(19) United States
(12) Patent Application Publication
(10) Pub. No.: US 2025/0249697 A1
(43) Pub. Date: Aug. 7, 2025

(54) LIQUID DISCHARGE APPARATUS AND DISCHARGE METHOD

(71) Applicant: CANON KABUSHIKI KAISHA, Tokyo (JP)

(72) Inventors: KAZUKI NARUMI, Tokyo (JP); HIROTO KANGO, Tokyo (JP)

(21) Appl. No.: 19/045,913

(22) Filed: Feb. 5, 2025

(30) Foreign Application Priority Data
Feb. 6, 2024 (JP) 2024-016442

(51) Int. Cl. B41M 3/00; B41J 2/165; C09D 11/54

(52) U.S. Cl. CPC B41M 3/001; B41J 2/16579; C09D 11/54

(57) ABSTRACT

A liquid discharge apparatus including: a discharge unit configured to discharge a plurality of types of liquid, a housing unit configured to house liquid discharged from the discharge unit in order to inspect a discharge state of the discharge unit; and a control unit configured to control the discharge unit, wherein the plurality of types of liquid include a first liquid and a reaction solution that reacts with the first liquid, and the control unit controls the discharge unit, such that the reaction between the first liquid and the reaction solution is suppressed, in the inspection of the discharge state.

### BACKGROUND OF THE INVENTION

### Field of the Invention

The present invention relates to a liquid discharge apparatus and a discharge method.

### Description of the Related Art

An inkjet recording apparatus is an example of a known liquid discharge apparatus. Inkjet recording apparatuses allow for an increase in the density of ink discharge ports (nozzles) and applications include document recording using plain paper and recording of high-quality photographic images such as silver halide photographs. Also, inkjet recording apparatuses are capable of fast and quiet recording and have the advantage of low running costs. On the other hand, with inkjet recording apparatuses, issues such as non-discharge of ink and deviation in the discharge direction can occur, due to the discharge ports becoming coated in dust, ink and other foreign matter. When issues such as non-discharge of ink and deviation in the discharge direction occur, the image quality desired by the user may not be obtained. Thus, a detection sensor or the like that detects the ink discharge state of the discharge ports is used. Japanese Patent Laid-Open No. 2006-248021 discloses a technology for performing non-discharge detection of a plurality of heads in a short time and reducing the total printing time.

### SUMMARY OF THE INVENTION

The present invention provides a technology for suppressing deposition of aggregates caused by the reaction of liquids used in inspection of the discharge state of discharge ports.

The present invention in one aspect provides a liquid discharge apparatus comprising: a discharge unit configured to discharge a plurality of types of liquid, a housing unit configured to house liquid discharged from the discharge unit in order to inspect a discharge state of the discharge unit; and a control unit configured to control the discharge unit, wherein the plurality of types of liquid include a first liquid and a reaction solution that reacts with the first liquid, and the control unit controls the discharge unit, such that the reaction between the first liquid and the reaction solution is suppressed, in the inspection of the discharge state.

According to the present invention, a technology for suppressing deposition of aggregates caused by the reaction of liquids used in inspection of the discharge state of discharge ports can be provided.

Further features of the present invention will become apparent from the following description of exemplary embodiments with reference to the attached drawings.

### BRIEF DESCRIPTION OF THE DRAWINGS

FIG. 1 is a perspective view showing the internal configuration of a liquid discharge apparatus.

FIG. 2 is a side view showing the periphery of a carriage.

FIG. 3 is a diagram showing discharge surfaces of discharge heads.

FIGS. 4A and 4B are diagrams for describing discharge inspection.

FIG. 5 is a block diagram for describing the hardware configuration of the liquid discharge apparatus.

FIG. 6 is a flowchart showing processing relating to discharge inspection.

FIG. 7 is a diagram for describing control of carriage movement during discharge inspection.

FIGS. 8A and 8B are diagrams for describing states inside an inspection unit.

FIGS. 9A to 9C are diagrams for describing reactive aggregation of a reaction solution and color ink.

FIGS. 10A to 10H are diagrams for describing reactive aggregation of a reaction solution and color ink.

FIG. 11 is a flowchart showing discharge inspection processing.

FIG. 12 is a flowchart showing processing relating to discharge inspection.

FIG. 13 is a flowchart showing discharge inspection processing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Incidentally, depending on the type of printing medium, in order to suppress issues such as beading and bleeding of ink on the printing medium, the viscosity of the ink is increased by causing the ink to react with a reaction solution and aggregating the colorant. With such a liquid discharge apparatus that discharges ink and a reaction solution, the ink reacts with the reaction solution inside a storage tank that stores waste liquid that was used in inspection of the discharge state of the discharge ports, and aggregates that occur due to the aggregation of components within the ink are deposited. When aggregates are deposited inside the storage tank due to inspection of the discharge state being repeatedly performed, the storage tank needs to be replaced more frequently.

The present invention provides a technology for suppressing deposition of aggregates caused by the reaction of liquids used in inspection of the discharge state of discharge ports.

### First Embodiment

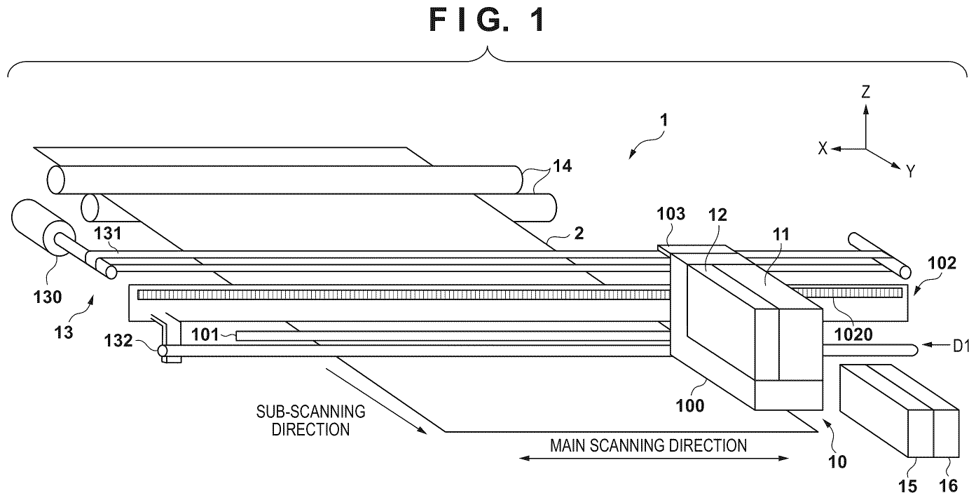

FIG. 1 is a perspective view showing an example of the internal configuration of the apparatus body of a liquid discharge apparatus 1 of the present embodiment. In the diagrams, arrows X, Y, and Z indicate directions that intersect each other, and, in the case of the present embodiment, the arrows X and Y indicate horizontal directions that are orthogonal to each other and respectively indicate a width direction and a depth direction of the liquid discharge apparatus 1, and the arrow Z indicates an up-down direction (height direction).

The liquid discharge apparatus 1 of the present embodiment is, for example, an inkjet recording apparatus that discharges ink and a reaction solution, which are liquids, onto a printing medium 2 and records an image on the printing medium 2. That is, in the present embodiment, a discharge apparatus for discharging a plurality of types of liquid will be described below.

Also, “recording” includes not only the case of forming meaningful information such as characters and graphics, but also the case of forming images, designs, patterns, and the like on a wide range of recording media, whether meaningful or not, or performing processing of media, and whether or not the images, designs, patterns, and the like are actualized so as to be visually perceivable by humans is not considered. Also, in the present embodiment, the “printing medium” is assumed to be paper in sheet form, but may be media such as cloth, plastic/film, and nonwoven fabric.

The liquid discharge apparatus 1 is provided with a carriage 10 and a movement mechanism 13 that moves the carriage 10 back and forth in the X direction. In the present embodiment, the movement mechanism 13 is a belt transmission mechanism. The movement mechanism 13 includes a carriage (CR) motor 130, a drive belt 131, and a guide shaft 132. Specifically, the movement mechanism 13 moves back and forth in the X direction following movement of the drive belt 131 whose drive source is the carriage (CR) motor 130, with the carriage 10, which is equipped with a discharge head 11 and a discharge head 12, being guided and supported by the guide shaft 132. Note that, in the following description, the movement direction of the carriage 10 may be referred to as the main scanning direction.

In the present embodiment, a plurality of discharge heads 11 and 12 are installed in the carriage 10. In the present embodiment, the liquid discharge apparatus 1 discharges ink and a reaction solution that reacts with the ink using the discharge heads 11 and 12. In the case of the present embodiment, the discharge head 11 is a recording head that discharges color inks of a plurality of colors that are supplied from a tank unit (not shown) onto the printing medium 2 and records an image. Also, the discharge head 12 is a recording head that discharges a reaction solution supplied from a tank unit (not shown) onto the printing medium 2 and records an image. The reaction solution is a liquid that reacts with components contained in the ink. The ink and reaction solution will be described in detail later. Also, the discharge heads 11 and 12 are provided to be removable from the carriage 10 and are replaceable.

Note that, in the present embodiment, two discharge heads 11 and 12 are installed in the carriage 10, but more than two discharge heads may be provided. For example, the carriage 10 may be provided with a discharge head for each type of ink and reaction solution.

The discharge head 11 of the present embodiment is, for example, a recording head that utilizes thermal energy to discharge ink. An electrothermal converter for generating thermal energy is provided, as a recording element, inside the discharge ports that are formed in the discharge head 11 and discharge ink. Note that the method for discharging ink is not limited to a method utilizing thermal energy and may be another method such as a method for discharging ink using piezoelectric elements. Note that the discharge head 12 may also be a recording head that discharges a reaction solution utilizing thermal energy similarly to the discharge head 11, or the discharge head 11 and the discharge head 12 may be recording heads that use respectively different methods.

Also, the guide shaft 132 is inserted into the carriage 10 in the main scanning direction. The guide shaft 132 is, for example, a support member that supports the carriage 10 in a guidable manner. The liquid discharge apparatus 1 forms an image on the printing medium 2 in a step-by-step manner, by alternately repeating movement of the discharge heads 11 and 12 installed in the carriage 10 in the main scanning direction and a conveying operation by a conveyance roller pair 14 described later.

Also, the carriage 10 is provided with a cable 101 that electrically connects a control unit (not shown) of the liquid discharge apparatus 1 described later to the discharge heads 11 and 12. The cable 101 has flexibility and is connected to the discharge heads 11 and 12 while tracking movement of the carriage 10 by the movement mechanism 13.

Also, the carriage 10 is provided with a sliding member (not shown) so as to contact the guide shaft 132. The carriage 10 is thereby supported by the guide shaft 132 in a state of being movable by the movement mechanism 13, for example. The sliding member (not shown) may, for example, be a gear, a bearing, a washer, or a ball screw.

Also, the carriage 10 and the drive belt 131 may be connected by a connecting member 103 provided between a carriage body 100 and the drive belt 131. The carriage 10 can thereby be moved by the movement mechanism 13 as described above. Also, the connecting member 103 may, for example, be a member that is removably fixed to the carriage body 100. Also, in the present embodiment, the carriage 10 and the drive belt 131 are connected by the connecting member 103, but the present invention is not limited thereto. For example, the carriage body 100 may be removably fixed to the drive belt 131.

The liquid discharge apparatus 1 is provided with the conveyance roller pair 14. The pair of conveyance rollers 14 sandwich the printing medium 2 and convey the printing medium 2 in a direction intersecting the main scanning direction with rotation thereof. Note that, in the following description, the direction (Y direction) that intersects the main scanning direction may be referred to as a sub-scanning direction.

The liquid discharge apparatus 1 is provided with a recovery unit 15. The recovery unit 15 is, for example, provided to the side of the conveyance path of the printing medium 2, within the movable range of the carriage 10. The recovery unit 15 is a unit that maintains and recovers the discharge performance of the discharge heads 11 and 12. The recovery unit 15 includes, for example, a cap that covers the discharge surface of the discharge heads 11 and 12, and a suction device (pump) that suctions ink and reaction solution from the discharge surface via the cap. By suctioning ink and reaction solution from the discharge surface via the cap, foreign matter on and around the discharge ports is removed, and the discharge performance of the discharge heads 11 and 12 can be recovered. The recovery unit 15 may, for example, maintain/recover the discharge performance of the discharge heads 11 and 12, before the ink or reaction solution is discharged by the discharge heads 11 and 12.

The liquid discharge apparatus 1 is provided with an inspection unit 16 that inspects the discharge state of the liquid of the discharge heads 11 and 12. The inspection unit 16 is, for example, provided to the side of the conveyance path of the printing medium 2, within the movable range of the carriage 10. The side of the conveyance path of the printing medium 2 is, in other words, a position that does not overlap with the conveyance path of the printing medium 2. In this way, by installing the inspection unit 16 at a position that does not overlap with the printing medium 2, the discharge heads 11 and 12 can, for example, be moved to a position over the inspection unit 16 and the discharge state thereof can be inspected, at any time during the operation for discharging ink or reaction solution onto the printing medium 2 by the discharge heads 11 and 12.

Note that, in the present embodiment, the recovery unit 15 and the inspection unit 16 are provided adjacent to each other, but the recovery unit 15 and the inspection unit 16 may be provided to be spaced apart from each other. Also, the recovery unit 15 and the inspection unit 16 may be provided so as to oppose each other across the conveyance path of the printing medium 2, within the movable range of the carriage 10.

Also, in the present embodiment, for example, the inspection unit 16 may be provided in the liquid discharge apparatus 1 so as to be replaceable by a provider (vendor) of the liquid discharge apparatus 1. That is, the inspection unit 16 may be provided in the liquid discharge apparatus 1 so as to not be replaceable on the user side. For example, the inspection unit 16 may be fixed inside the apparatus body of the liquid discharge apparatus 1. Due to the inspection unit 16 being provided so as to not be replaceable on the user side, the user can be prevented from getting stained with waste liquid used in the discharge inspection described later or the like, when replacing the inspection unit 16, for example.

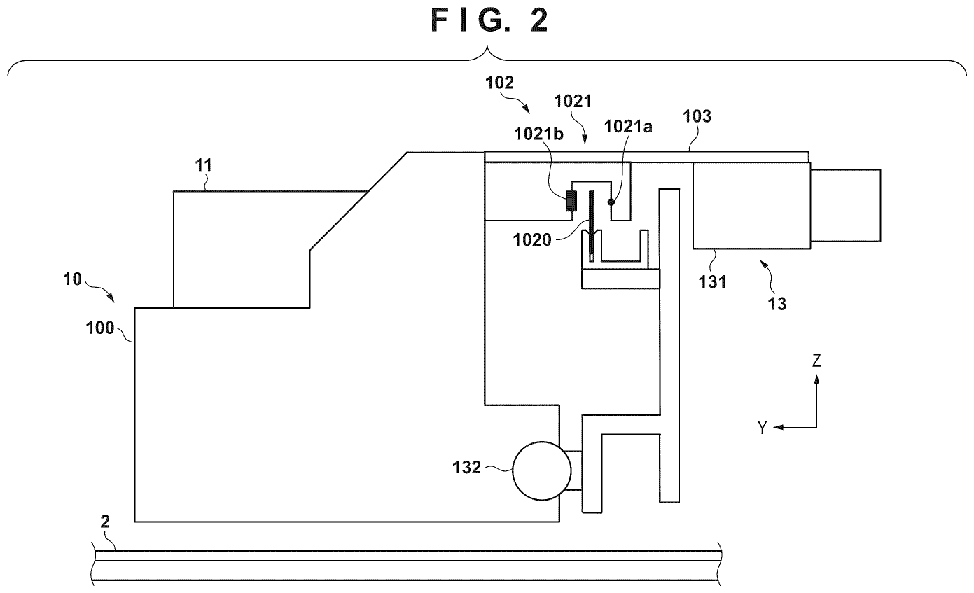

FIG. 2 will be referred to here. FIG. 2 is a diagram showing a portion (peripheral portion of carriage 10) when the inside of the apparatus body of the liquid discharge apparatus 1 is viewed from the side, and corresponds to the view in the direction indicated by the D1 direction arrow in FIG. 1.

As shown in FIG. 2, the liquid discharge apparatus 1 is provided with a position detection unit 102 that detects the position of the carriage 10. The position detection unit 102 includes an encoder sensor 1021 attached to the upper surface of the carriage 10 and a linear scale 1020 provided in the main scanning direction similarly to the guide shaft 132. The encoder sensor 1021 is fixed to the upper surface of the carriage 10 so as to sandwich the linear scale 1020 with a light receiving unit 1021a and a light emitting unit 1021b. The position detection unit 102 detects the movement speed and position of the carriage 10, as a result of the encoder sensor 1021 reading slits printed on the linear scale 1020 at regular intervals. That is, the position detection unit 102 can also be said to be a unit that acquires information such as the movement speed and position of the carriage 10.

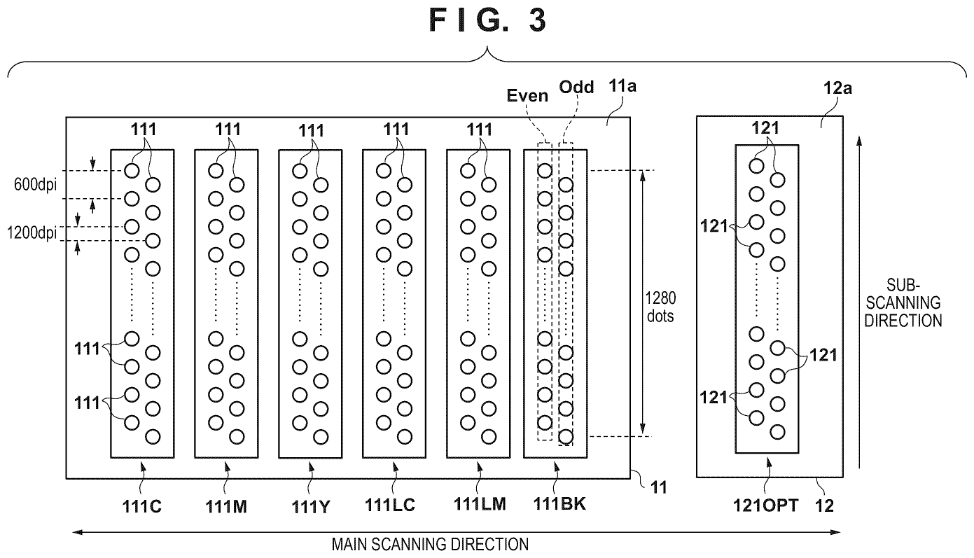

FIG. 3 will now be referred to. FIG. 3 is a diagram illustrating the liquid discharge surfaces of the discharge head 11 and the discharge head 12 of the present embodiment and is also a schematic diagram of the discharge head 11 and the discharge head 12 as viewed from the printing medium 2 side.

As shown in FIG. 3, a plurality of discharge ports 111 for discharging ink are provided on a discharge surface 11a of the discharge head 11. Also, a plurality of discharge ports 121 for discharging reaction solution are provided on a discharge surface 12a of the discharge head 12. Discharge ports 111 and 121 are, in other words, nozzles.

The discharge head 11 has a plurality of discharge port columns 111C to 111BK formed for the respective ink colors. Also, in the discharge port columns 111C to 111BK, 1280 discharge ports 111 are formed at a density of 1200 ports per inch, for example.

The discharge port column 111C is an array of a plurality of discharge ports 111 that discharge cyan ink. The discharge port column 111M is an array of a plurality of discharge ports 111 that discharge magenta ink. The discharge port column 111Y is an array of a plurality of discharge ports 111 that discharge yellow ink. The discharge port column 111BK is an array of a plurality of discharge ports 111 that discharge black ink. The discharge port column 111LC is an array of a plurality of discharge ports 111 that discharge light cyan ink. The discharge port column 111 LM is an array of a plurality of discharge ports 111 that discharge light magenta ink. Note that the discharge port columns 111C to 111BK may be formed so as to be adjacent to each other. The size of the discharge head 11 can thereby be reduced.

Also, two columns of discharge ports 111 consisting of an even column and an odd column are arrayed in each of the discharge port columns 111C to 111BK. In the even and odd columns, the discharge ports 111 are, for example, provided at a density of 600 ports per inch in the sub-scanning direction. The even and odd columns are disposed to be shifted by 1/1200 inch from each other in the sub-scanning direction such that the discharge ports 111 are staggered.

The discharge head 12 has a discharge port column 121OPT of the discharge ports 121 that discharge the reaction solution. Also, in the discharge port column 121OPT, 1280 discharge ports 121 are, for example, formed at a density of 1200 ports per inch. The discharge port column is, in other words, a nozzle column.

Also, in the discharge port column 121OPT, two columns of discharge ports 121 consisting of an even column and an odd column are arrayed, similarly to the discharge head 11. The even and odd columns are, for example, provided with discharge ports 121 at a density of 600 ports per inch in the sub-scanning direction. The even and odd columns are disposed to be shifted by 1/1200 inch in the sub-scanning direction such that the discharge ports 121 are staggered.

That is, the discharge heads 11 and 12 are able to form 1200 dots per inch on the printing medium 2. Also, the liquid discharge apparatus 1 is able to form an image at a recording density of 1200 dpi (dot/inch) in the sub-scanning direction using these discharge heads 11 and 12. The liquid discharge apparatus 1 respectively discharges ink and reaction solution from the discharge ports 111 and 121 while scanning the discharge head 11 and the discharge head 12 in the main scanning direction, and forms dots at a recording density of 2400 dpi in the main scanning direction and 1200 dpi in the sub-scanning direction.

Note that the amount of ink discharged from each of the discharge ports 111 (discharge amount) is, for example, approximately 4.5 pl. Note that the discharge amount of black ink may be set higher than for inks of other colors in order to realize a high concentration.

Also, in the present embodiment, the discharge head 11 discharges inks of six colors, namely, cyan (C), magenta (M), yellow (Y), light cyan (LC), light magenta (LM), and black (BK), from the discharge port columns 111C to 111BK, respectively, but the present invention is not limited thereto. For example, the liquid discharge apparatus 1 may have a discharge head for each of the six colors. Also, in the present embodiment, an example is described in which the discharge head 11 discharges inks of the six colors described above, but the present invention is not limited thereto. For example, the discharge head 11 may discharge inks such as red ink, green ink, blue ink, and white ink, in addition to inks of the six colors described above. By also using inks of other colors in addition to the six colors described above, the color development of the printing medium 2 can be improved, for example.

In the present embodiment, the liquid discharge apparatus 1 as described above is separately provided with the discharge head 11 for discharging ink and the discharge head 12 for discharging reaction solution. In other words, it can also be said that the liquid discharge apparatus 1 has the discharge heads 11 and 12 for each type of liquid. The reaction between the ink and the reaction solution at the discharge surfaces and the discharge ports can thereby be suppressed, compared to when the ink and the reaction solution are discharged from the same discharge head.

Also, in the present embodiment, as shown in FIG. 3, the discharge port columns 111C to 111BK of the discharge head 11 and the discharge port column 121OPT of the discharge head 12 are provided to be spaced apart from each other. By adopting such a configuration, even if the ink and reaction solution discharged from the discharge heads 11 and 12 form a mist that is suspended in the air, for example, soiling due to the misted ink and reaction solution reacting on the discharge surfaces 11a and 12a can be suppressed. Note that, in the following description, misted ink and reaction solution that is suspended in the air may be referred to as suspended mist.

Note that, in the present embodiment, an example is given in which the discharge head 11 and the discharge head 12 are provided separately in the liquid discharge apparatus 1, but the present invention is not limited thereto. For example, the liquid discharge apparatus 1 may be configured to discharge ink and reaction solution from the same discharge head. Specifically, for example, the discharge port columns 111C to 111BK for discharging a plurality of types of ink and the discharge port column 121OPT for discharging reaction solution may be formed on the same discharge head. Also, in this case, the discharge port columns 111C to 111BK and the discharge port column 121OPT for discharging the reaction solution may be formed to be spaced apart from each other. It is thereby possible to suppress soiling of the discharge heads by suspended mist as described above.

### Ink Composition

Next, formulation of ink in the present embodiment will be described in detail. Also, in the present specification, “part” and “%” are mass bases unless specified otherwise.

### Creation of Dispersion of Fine Resin Particles

The ink of the present embodiment contains water-soluble fine resin particles for adhering colorant (pigment) to the printing medium and improving the abrasion resistance (fixability) of the recorded image. The fine resin particles melt due to heat, and film formation of the fine resin particles and drying of the solvent contained in the ink occur due to heat being applied. In the present embodiment, the “fine resin particles” are polymer fine particles dispersed in water.

The fine resin particles may, for example, be acrylic fine resin particles synthesized by emulsion polymerization of a monomer such as (meth)acrylic acid alkyl ester or (meth)acrylic acid alkylamide. Also, the fine resin particles may, for example, be styrene-acrylic fine resin particles synthesized by emulsion polymerization of a styrene monomer with (meth)acrylic acid alkyl ester, (meth)acrylate alkylamide or the like. The fine resin particles may, for example, also be polyethylene fine resin particles, polypropylene fine resin particles, polyurethane fine resin particles, styrene-butadiene fine resin particles, or the like. Also, the fine resin particles may be core-shell fine resin particles in which the core part and shell part constituting the fine resin particles have different polymer compositions. Also, the fine resin particles may be fine resin particles obtained by using acrylic fine particles synthesized in advance in order to control the particle size as seed particles and performing emulsion polymerization in the vicinity thereof. Furthermore, the fine resin particles may be hybrid fine resin particles obtained by chemically bonding different fine resin particles such as acrylic fine resin particles and urethane fine resin particles.

Also, “polymer fine particles dispersed in water” may, for example, be a dispersion of fine resin particles in a form obtained by homopolymerizing a monomer having a dissociable group or copolymerizing a plurality of such monomers, that is, a dispersion of so-called self-dispersing fine resin particles. Here, examples of the dissociable group include a carboxyl group, a sulfonic acid group, and a phosphate group, and examples of monomers having this dissociable group include acrylic acid and methacrylic acid. Furthermore, the dispersion of fine resin particles may be a dispersion of so-called emulsified dispersion-type fine resin particles obtained by dispersing fine resin particles with an emulsifier. As the emulsifier, a material having an anionic charge can be used regardless of the low molecular weight and high content.

The dispersion of fine resin particles used in the present embodiment was obtained by first adding the following three additive solutions dropwise little by little while stirring in a state heated to 70° C. in a nitrogen atmosphere and performing polymerization for 5 hours. The three additive solutions are a hydrophobic monomer consisting of methyl methacrylate (28.5 parts), a liquid mixture containing a hydrophilic monomer consisting of sodium p-styrene sulfonate (4.3 parts) and water (30 parts), and a liquid mixture containing a polymerization initiator consisting of potassium persulfate (0.05 parts) and water (30 parts). In this way, a dispersion of fine resin particles of 20% by mass was obtained.

Hereinafter, methods for preparing the inks and reaction solution will be described.

### Preparation of Black Pigment Dispersion

First, an anionic polymer P-1 [styrene/butyl acrylate/acrylic acid copolymer (polymerization ratio (weight ratio)=30/40/30) acid value 202, weight average molecular weight 6500] was prepared. The anionic polymer P-1 was neutralized with an aqueous solution of potassium hydroxide and diluted with ion exchange water to produce a homogeneous polymer aqueous solution of 10% by mass.

600 g of the polymer solution, 100 g of carbon black, and 300 g of ion exchange water were mixed and mechanically stirred for a predetermined time, before removing non-dispersion containing coarse particles by centrifugal separation to obtain a black dispersion. The obtained black dispersion had a pigment concentration of 10% by mass.

### Preparation of Magenta Pigment Dispersion

First, an AB block polymer having an acid value of 300 and a numerical average molecular weight of 2500 was made by a conventional method, using benzyl acrylate and methacrylic acid as raw materials, and the AB block polymer was neutralized with an aqueous solution of potassium hydroxide and diluted with ion exchange water to produce a homogeneous polymer aqueous solution of 50% by mass.

100 g of the polymer solution, 100 g of C.I. pigment red 122, and 800 g of ion exchange water were mixed and mechanically stirred for a predetermined time, before removing non-dispersion containing coarse particles by centrifugal separation to obtain a magenta dispersion. The obtained magenta dispersion had a pigment concentration of 10% by mass.

### Preparation of Cyan Pigment Dispersion

First, an AB block polymer having an acid value of 250 and a numerical average molecular weight of 3000 was made by a conventional method, using benzyl acrylate and methacrylic acid as raw materials, and the AB block polymer was neutralized with an aqueous solution of potassium hydroxide and diluted with ion exchange water to produce a homogeneous polymer aqueous solution of 50% by mass.

200 g of the polymer solution, 100 g of C.I. pigment blue 15:3, and 700 g of ion exchange water were mixed and mechanically stirred for a predetermined time, before removing non-dispersion containing coarse particles by centrifugal separation to obtain a cyan dispersion. The obtained cyan dispersion had a pigment concentration of 10% by mass.

### Preparation of Yellow Pigment Dispersion

First, the anionic polymer P-1 was neutralized with an aqueous solution of potassium hydroxide and diluted with ion exchange water to produce a homogeneous polymer aqueous solution of 10% by mass.

300 g of the polymer solution, 100 g of C.I. pigment yellow 74, and 600 g of ion exchange water were mixed and mechanically stirred for a predetermined time, before removing non-dispersion containing coarse particles by centrifugal separation to obtain a yellow dispersion. The obtained yellow dispersion had a pigment concentration of 10% by mass.

### Preparation of Ink

After mixing the components (unit: %) shown in the upper part of Table 1, the pigment inks 1 to 6 were each prepared by pressure-filtering with a membrane filter (HDC II filter; made by Pall Corporation) having a pore size of 1.2 μm. The amount of ion exchange water used was to achieve a total amount of components of 100.0%. Note that Acetylenol E100 is a surfactant manufactured by Kawaken Fine Chemicals. The lower part of Table 1 shows the content of pigment in the pigment inks (unit: %). Cartridges were respectively filled with the inks thus obtained.

TABLE 1

| | 1 | 2 | 3 | 4 | 5 | 6 |
|---|---|---|---|---|---|---|
| Name of ink | BK | C | LC | M | LM | Y |
| Black pigment | 20 | | | | | |
| dispersion | | | | | | |
| Cyan pigment | | 25 | 5 | | | |
| dispersion | | | | | | |
| Magenta pigment | | | | 30 | 6 | |
| dispersion | | | | | | |
| Yellow pigment | | | | | | 35 |
| dispersion | | | | | | |
| Fine resin particle | 40 | 40 | 40 | 40 | 40 | 40 |
| dispersion | | | | | | |
| Zonyl FSO-100 | 0.05 | 0.05 | 0.05 | 0.05 | 0.05 | 0.025 |
| (fluorinated | | | | | | |
| surfactant (DuPont)) | | | | | | |
| 2-Methyl-1,3- | 15 | 15 | 15 | 15 | 15 | 15 |
| propanediol | | | | | | |
| 2-Pyrrolidone | 5 | 5 | 5 | 5 | 5 | 5 |
| Acetylene glycol | 0.5 | 0.5 | 0.5 | 0.5 | 0.5 | 0.5 |
| EO adduct | | | | | | |
| (Kawaken Fine | | | | | | |
| Chemicals) | | | | | | |
| Ion exchange | Residual | Residual | Residual | Residual | Residual | Residual |
| water | | | | | | |
| Pigment | 2 | 2.5 | 0.5 | 3 | 0.6 | 3.5 |
| concentration | | | | | | |

### Preparation of Reaction Solution

The reaction solution used in the present embodiment contains a reactive component that reacts with the pigment contained in the ink and causes the pigment to aggregate or gel. This reactive component is, specifically, a component that, when mixed on a printing medium or the like with ink having a pigment that is stably dispersed in an aqueous medium by the action of an ionic group, is able to destroy the dispersion stability of the ink. Magnesium sulfate is used as the reactive component in the present embodiment.

Note that, in the present embodiment, the case where magnesium sulfate, which is a polyvalent metal salt, is used as the reactive component is described as an example, but the present invention is not limited thereto. For example, various water-soluble organic acids and other polyvalent metal salts may be used as the reactive component of the reaction solution. Also, the content of the organic acid or polyvalent metal salt is, for example, preferably 0.1% by mass or more and 90.0% by mass or less, and more preferably 1.0% by mass or more and 70.0% by mass or less, based on the total mass of the composition included in the reaction solution.

In the present embodiment, as described above, magnesium sulfate (manufactured by FUJIFILM Wako Pure Chemical Corporation Co., Ltd.) is used as the reactive component, and the reaction solution is produced by mixing the following components.

| | | |
|---|---|---|
| Magnesium sulfate | 2 | parts |
| 2-Pyrrolidone | 2 | parts |
| 2-Methyl-1,3-propanediol | 15 | parts |
| Acetylene glycol EO adduct | 0.5 | parts |
| (Manufactured by Kawaken | | |
| Fine Chemicals Co., Ltd.) | | |

| | |
|---|---|
| Ion exchange water | residual part |

### Inspection Unit

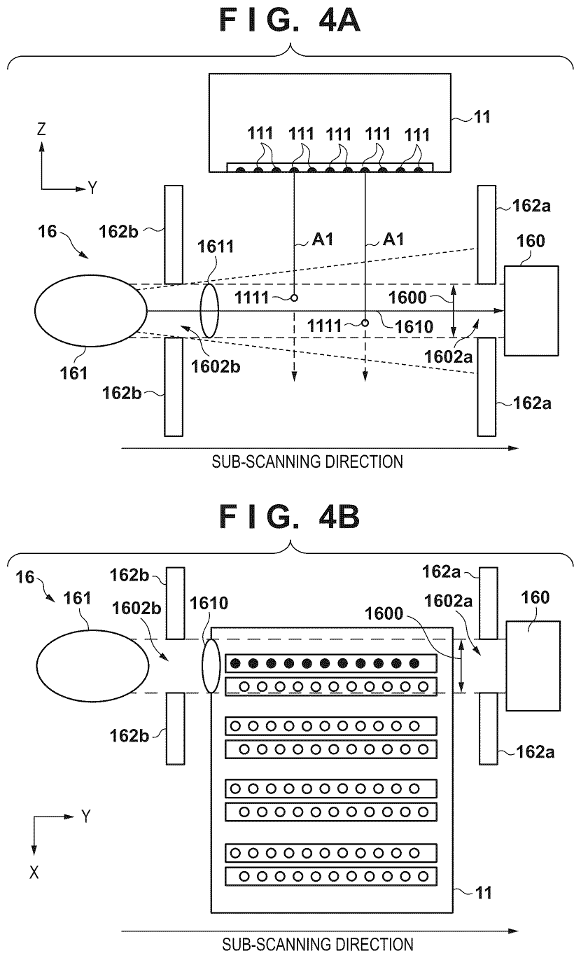

FIGS. 4A and 4B are diagrams for describing the inspection unit 16. FIG. 4A is a schematic diagram of the inspection unit 16 at the time of discharge inspection as viewed in the X direction. FIG. 4B is a schematic diagram of the inspection unit 16 at the time of discharge inspection as viewed in the Z direction. Note that, in FIGS. 4A and 4B, the inspection unit 16 at the time of discharge inspection of the discharge head 11 is illustrated as an example, but the configuration in the case of discharging reaction solution as a liquid from the discharge head 12 is similar.

As shown in FIGS. 4A and 4B, the inspection unit 16 in the present embodiment has a light receiving element 160 and a light emitting element 161. The inspection unit 16 irradiates light 1610 from the light emitting element 161 when inspecting the discharge state of the discharge head 11 or the discharge head 12, for example. When discharge inspection is performed by the inspection unit 16, ink droplets 1111 are discharged from the discharge head 11. When the ink droplets 1111 are discharged from the discharge head 11, for example, the amount of light received by the light receiving element 160 changes. In this way, the inspection unit 16 inspects the discharge state of the discharge ports 111 of the discharge head 11, based on the change in the amount of light received by the light receiving element 160. That is, the inspection unit 16 inspects the discharge state of the discharge heads 11 and 12 using an optical sensor. The inspection unit 16 is, in other words, also a detection unit that detects the discharge state of the discharge heads 11 and 12.

Also, as shown in FIGS. 4A and 4B, the inspection unit 16 in the present embodiment includes an aperture (diaphragm) 162a provided on the light receiving element 160 side and an aperture (diaphragm) 162b provided on the light emitting element 161 side. The apertures 162a and 162b may, for example, be provided in the side surfaces of a housing unit described later. Also, the aperture 162a has an opening 1602a, and the aperture 162b has an opening 1602b. The sizes (opening diameters) of the openings 1602a and 1602b can be respectively adjusted by the apertures 162a and 162b, for example.

Also, a light beam 1611, which is the entirety of the light 1610 irradiated from the light emitting element 161 and incident on the light receiving element 160, is an inspection area 1600 that can be inspected by the inspection unit 16 at the time of discharge inspection. For example, the sizes of the openings 1602a and 1602b can be changed, by respectively adjusting the apertures 162a and 162b as described above. Changing the size of the openings 1602a and 1602b also, in other words, changes the size of the inspection area 1600. For example, the size of the inspection area 1600 may also be changed according to the size of the ink or reaction solution that is discharged by the discharge head 11 or the discharge head 12. For example, if the ink that is discharged from the discharge head 11 or the reaction solution that is discharged from the discharge head 12 is very small, the size of the inspection area 1600 may be reduced. The signal-to-noise ratio thereby increases and the inspection accuracy can be enhanced.

Discharge inspection will now be described in detail. When performing discharge inspection, the liquid discharge apparatus 1 moves the discharge head 11 targeted for inspection to an upper part of the inspection unit 16. Specifically, for example, the liquid discharge apparatus 1 moves the discharge port column of the discharge head 11 that is targeted for inspection to an inspection position. The inspection position is the position at which the inspection unit 16 is provided. Specifically, the inspection position is, for example, an upper part of the inspection area 1600. For example, the liquid discharge apparatus 1 moves the discharge port column targeted for inspection to the inspection position by moving the carriage 10 with the movement mechanism 13 described above. Movement of the carriage 10 will be described in detail later. Note that, in the present embodiment, a configuration is described in which the carriage 10 is moved at the time of discharge inspection, but the inspection unit 16 may be moved, for example.

Also, the liquid discharge apparatus 1 controls the inspection unit 16 in be a state in which discharge inspection is possible at the time of the discharge inspection. For example, the liquid discharge apparatus 1 performs control such that light is irradiated from the light emitting element 161 of the inspection unit 16 and the change in the amount of light received by the light receiving element 160 is acquired.

Also, the liquid discharge apparatus 1 performs control for causing the discharge head 11 to discharge ink at the time of discharge inspection. For example, the liquid discharge apparatus 1 sequentially drives the recording elements inside the discharge ports 111 of the discharge port column targeted for inspection one by one in a predetermined cycle and causes the discharge ports 111 to each discharge a predetermined number of ink droplets 1111 within a predetermined time. The ink droplets 1111 travel along a flight path represented by arrows A1 in FIG. 4A, for example, passing through the inspection area 1600 and blocking the light beam 1611, for example. When the amount of light received by the light receiving element 160 decreases due to being blocked by the travelling ink droplets 1111, the signal value of the inspection signal output from the light receiving element 160 changes. The liquid discharge apparatus 1 determines whether the ink droplets 1111 from the discharge ports 111 were discharged normally, based on the amount of light received by the light receiving element 160 within the predetermined time.

Also, if the signal value of the detection signal output from the light receiving element 160 at the time of discharge inspection is less than a threshold value set in advance, the liquid discharge apparatus 1 determines that liquid has been discharged normally from the discharge head, and stores information indicating that the discharge ports 111 targeted for inspection are discharge ports that can perform discharge normally. On the other hand, if the signal value did not fall below the preset threshold value within the predetermined time, the liquid discharge apparatus 1 determines that liquid was not discharged normally, and stores information indicating that the discharge ports 111 targeted for inspection are discharge ports with poor discharge.

### Example Control Configuration of Liquid Discharge Apparatus

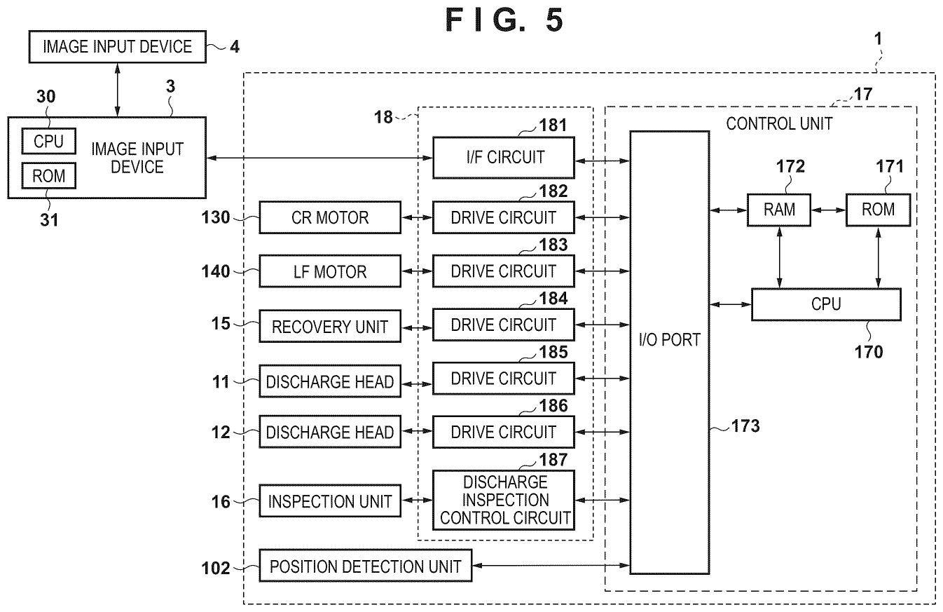

Next, the control configuration of the liquid discharge apparatus 1 will be described. FIG. 5 is a block diagram showing an example of the hardware configuration of the liquid discharge apparatus 1 in the present embodiment. The liquid discharge apparatus 1 is provided with a control unit 17 that performs overall control of the liquid discharge apparatus 1. The control unit 17 includes a CPU 170, a ROM 171, a RAM 172, and an input/output (I/O) port 173, for example.

The CPU 170 is a system control unit including a processor, and performs overall control of the liquid discharge apparatus 1. The CPU 170 executes various types of processing by, for example, reading out various control programs stored in a storage medium such as the ROM 171 to the RAM 172 which serves as a work area and executing the control programs. Also, the processing by the liquid discharge apparatus 1 described below is, in one example, realized by the CPU 170 executing programs stored in the ROM 171.

The CPU 170 may also include, as function blocks thereof, a driver unit, a sequence control unit, an image processing unit, a timing control unit, and a head control unit, for example. The sequence control unit performs overall control of recording, and, specifically, starts and stops the image processing unit, the timing control unit, and the head control unit, controls conveyance of the printing medium 2, and controls movement of the carriage 10. Control of the function blocks is executed by the sequence control unit reading out various types of programs from the ROM 171 and executing the programs. The driver unit generates control signals directed to the ROM 171, drive circuits 182 to 186, a discharge inspection control circuit 187, and the like, based on instructions from the sequence control unit, and transmits input signals from the blocks to the sequence control unit.

The image processing unit performs image processing for color-separating and converting input image data input from an external image input device 3 and converting the resultant image data into recording data that is recordable by the discharge heads 11 and 12. The timing control unit transfers the recording data generated through conversion by the image processing unit to the head control unit, in conjunction with the position of the carriage 10. The timing control unit also controls a signal that is for determining the discharge state of the liquid and is synchronized with the discharge from each nozzle. The head control unit converts the recording data input from the timing control unit into a discharge signal and outputs the discharge signal. Also, when correction is required, the head control unit outputs an adjustment control signal for performing correction, based on an instruction from the sequence control unit, and transmits the adjustment control signal to the drive circuits 185 and 186.

The ROM 171 is, for example, a non-volatile storage, and stores control programs that are executed by the CPU 170, various types of information, and the like. The various types of information may, for example, include information such as inspection data and reference values related to the discharge state, discharge state inspection results, and the thickness of the printing medium 2.

The various types of information may, for example, also include information on the inspection position. The inspection position is, for example, position information of the inspection unit 16. For example, at the time of discharge inspection, the CPU 170 may perform movement control of the carriage 10 so as to acquire information on the inspection position stored in the ROM 171 and perform inspection of the discharge heads 11 and 12 at the inspection position.

The RAM 172 is, for example, a volatile storage, and is used as a main memory, a work memory, or the like when executing various programs stored in a storage unit such as the ROM 171.

The I/O port 173 is, for example, an interface for signal input and output, and a circuit unit 18, the position detection unit 102, and the like are connected thereto. Various types of signals from the control unit 17 are output to the circuit unit 18 and various types of signals from the circuit unit 18 are input to the control unit 17, via the I/O port 173. Also, a detection signal from the position detection unit 102 which detects the position of the carriage 10 is input to the control unit 17, via the I/O port 173. For example, at the time of discharge inspection, the control unit 17 may acquire the detection signal from the position detection unit 102, via the I/O port 173, in order to move the carriage 10 to the inspection position. Note that sensors such as a temperature and humidity sensor (not shown) that detects the temperature and humidity around the liquid discharge apparatus 1 may be connected to the I/O port 173.

The circuit unit 18 includes, for example, an interface (I/F) circuit 181, the drive circuits 182 to 186, and the discharge inspection control circuit 187.

The I/F circuit 181 is connected to the external image input device 3 in a wireless or wired manner, for example. The I/F circuit 181 is a circuit that transfers image information such as image data input from the image input device 3 to the control unit 17. The image input device 3 is, for example, a host computer. The image input device 3 has, for example, a CPU 30 that is required when transferring image data, a RAM that serves as a work area for when implementing various types of image processing, and a recording element such as a ROM 31 that serves as a recording medium. In the present embodiment, the image input device 3 external to the liquid discharge apparatus 1 may be an information processing apparatus such as a PC, or may be an image reader or the like. Also, for example, an image input device 4 such as a scanner or a digital camera or any of various types of storage media such as a hard disk of an external device (not shown) are connected to the image input device 3. Multi-value image data that is saved to the image input device 4 or any of various storage media of an external device (not shown) is input to the image input device 3.

The drive circuit 182 is, for example, a circuit for driving the CR motor 130, and drives the CR motor 130 by generating a drive pulse, in accordance with a signal input from a control unit such as the sequence control unit or the driver unit.

The drive circuit 183 is, for example, a circuit for driving an LF motor 140, and drives the LF motor 140 by generating a drive pulse, in accordance with a signal input from a control unit such as the sequence control unit or the driver unit.

The drive circuit 184 is, for example, a circuit for driving the recovery unit 15, and drives the recovery unit 15 by generating a drive pulse, in accordance with a signal input from a control unit such as the sequence control unit or the driver unit. Specifically, for example, the drive circuit 184 may drive a recovery operation motor (not shown) provided in the recovery unit 15. The recovery operation motor (not shown) is a motor for performing an operation for suctioning ink from the nozzles of the discharge heads 11 and 12.

The drive circuit 185 is, for example, a circuit for driving the discharge head 11, and generates a drive pulse in accordance with a discharge signal input from a control unit such as the head control unit and applies the drive pulse to the discharge head 11. The drive circuit 186 is, for example, a circuit for driving the discharge head 12, and generates a drive pulse in accordance with a discharge signal input from a control unit such as the head control unit and applies the drive pulse to the discharge head 12.

The discharge inspection control circuit 187 is, for example, a circuit for driving the inspection unit 16, and drives the inspection unit 16 by generating a drive pulse, in accordance with a signal input from a control unit such as the sequence control unit or the driver unit.

### Recovery Operation and Discharge Inspection

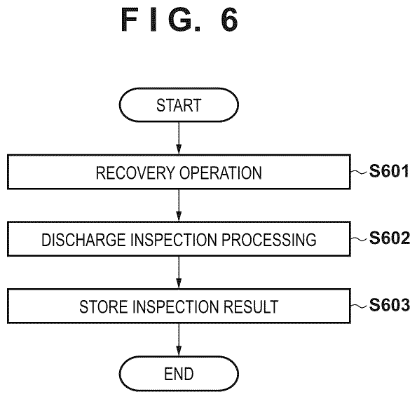

FIG. 6 is a flowchart showing an example of a series of processing relating to discharge inspection that is executed by the liquid discharge apparatus 1 of the present embodiment. The processing that is executed by the liquid discharge apparatus 1 of FIG. 6 is realized by, for example, a control program stored in a memory such as the ROM 171 being unpacked in the RAM 172 and executed by the CPU 170.

The liquid discharge apparatus 1 executes the processing of FIG. 6 at a predetermined timing, for example. In the present embodiment, the predetermined timing is, for example, when the liquid discharge apparatus 1 starts the recovery operation. The recovery operation may, for example, be a suction operation for removing air bubbles, impurities and the like from inside the head, by suctioning liquid from the discharge ports 111 of the discharge head 11 or the discharge ports 121 of the discharge head 12 using a recovery operation motor (not shown) of the recovery unit 15. Also, the recovery operation may, for example, be a wiping operation for wiping away droplets on the discharge surface 11a or the discharge surface 12a with the recovery unit 15. Also, the recovery operation may, for example, be a preliminary discharge operation for adjusting the discharge operation in advance when the discharge heads 11 and 12 discharge liquid onto the printing medium 2.

Note that the liquid discharge apparatus 1 may start the recovery operation when the liquid discharge apparatus 1 is powered on, for example. Also, the liquid discharge apparatus 1 may start the recovery operation, when discharging liquid onto the printing medium 2 or when discharging of liquid onto the printing medium 2 is completed. That is, the liquid discharge apparatus 1 may start the recovery operation before printing is started or after printing is completed.

In step S601, the liquid discharge apparatus 1 performs the recovery operation on the discharge head 11 or the discharge head 12. In step S602, the liquid discharge apparatus 1 performs discharge inspection of the discharge head 11 or the discharge head 12. Discharge inspection will be described in detail later. In step S603, the liquid discharge apparatus 1 stores the result of the discharge inspection of step S602. For example, the liquid discharge apparatus 1 may store non-discharging nozzle information as the result of the discharge inspection. The non-discharging nozzle information may, for example, be information on the discharge ports 111 of the discharge head 11 or the discharge ports 121 of the discharge head 12 that are determined to be discharge ports with poor discharge in the processing of step S602.

In this way, the liquid discharge apparatus 1 performs discharge inspection after performing the recovery operation. For example, dust, air bubbles and the like inside the discharge heads 11 and 12 (inside the nozzles) can be removed by the recovery operation. That is, the accuracy of discharge inspection can be enhanced by performing the discharge inspection after the recovery operation.

Also, in the present embodiment, a mode in which the liquid discharge apparatus 1 ends the processing of FIG. 6 after step S603 is described as an example, but the present invention is not limited thereto. For example, after step S603, the liquid discharge apparatus 1 may execute processing for discharging liquid onto the printing medium 2. That is, the liquid discharge apparatus 1 may perform printing after step S603. In this case, the liquid discharge apparatus 1 may, for example, perform control such that discharge ports that are determined and stored to have poor discharge in the discharge inspection are not used, when discharging liquid onto the printing medium 2.

Also, in the present embodiment, the case where the processing of FIG. 6 is executed at the start of the recovery operation is described as an example, but the present invention is not limited thereto. For example, the processing of FIG. 6 may be started based on a user operation, for example. Specifically, the liquid discharge apparatus 1 may receive an instruction from the user to start the processing of FIG. 6, via an operation unit (not shown) such as a touch panel, a mouse or a keyboard.

### Movement Control of Carriage

Next, an example of control of the movement of the discharge heads 11 and 12 by the liquid discharge apparatus 1 of the present embodiment will be described. As described above, the carriage 10 is provided with a sliding member (not shown), and the carriage 10 is thereby supported in a movable state by the guide shaft 132. The liquid discharge apparatus 1 performs control for moving the carriage 10, at times such as when discharging liquid onto the printing medium 2 using the discharge heads 11 and 12 and when performing discharge inspection processing on the discharge heads 11 and 12, for example. The present example will be described assuming control of the movement of the carriage 10 in the case of performing the discharge inspection processing on the discharge head 11.

For example, the liquid discharge apparatus 1 moves the carriage 10 holding the discharge heads 11 and 12 to the inspection position using the CR motor 130. The liquid discharge apparatus 1 needs to apply a force greater than the static friction force between the guide shaft 132 and the sliding member (not shown), in order to move the carriage 10 that is in a stopped state. The liquid discharge apparatus 1 is able to move the carriage 10, by using the CR motor 130 to apply a force greater than or equal to the static friction force to the carriage 10. For example, an inertial force acts on the carriage 10 that has started moving as a result of the force applied by the CR motor 130. In the case where the carriage 10 is stopped after being moved, it is thereby necessary for the carriage 10 to be moved a predetermined distance. In the following description, the minimum distance over which it is possible for the liquid discharge apparatus 1 to stop the carriage 10 may be referred to as the minimum movement distance.

For example, when the static friction force between the sliding member (not shown) and the guide shaft 132 is small, the carriage 10 at rest can be moved with a small force, and thus the inertial force also decreases. On the other hand, this static friction force may increase. For example, the static friction force can increase, depending on the weight of the carriage 10 and the discharge heads 11 and 12. Also, for example, liquids such as ink and reaction solution discharged from the discharge heads 11 and 12 may form a suspended mist that is suspended in the air and does not land on the printing medium 2 or the like, and this suspended mist may adhere to the guide shaft 132 or the like. Also, the amount of suspended mist adhering to the guide shaft 132 can increase, during the repeated discharge of liquid from the discharge heads 11 and 12 by the liquid discharge apparatus 1, for example. For example, the static friction force between the guide shaft 132 and the sliding member (not shown) can increase when suspended mist adheres to the guide shaft 132. For example, if the static friction force increases, the liquid discharge apparatus 1 needs to apply a large force in order to move the carriage 10 at rest, and the minimum movement distance can be large.

Also, as described above, the size of the inspection area 1600 may be changed, according to the size of the liquid that is discharged from the discharge heads 11 and 12 in the discharge inspection. For example, if the liquid that is discharged from the discharge heads 11 and 12 is very small, the size of the inspection area 1600 may be reduced in order to improve the inspection accuracy. For example, if the discharge head targeted for inspection moves outside the inspection area 1600 when the inspection area 1600 has been reduced, the discharge head targeted for inspection can be erroneously determined to have poor discharge despite discharging liquid normally. Accordingly, movement control of the carriage 10 by the liquid discharge apparatus 1 requires high stopping accuracy.

The liquid discharge apparatus 1 may possibly not be able to accurately move the carriage 10 to a desired position, in cases such as when moving the carriage 10 by the minimum movement distance, when suspended mist adheres to the guide shaft 132, and when the inspection area 1600 is small, for example. Accordingly, in the present embodiment, the liquid discharge apparatus 1 moves the carriage 10 from a position that is at a greater distance than the minimum movement distance, at times such as discharge inspection, for example. High stopping accuracy of the carriage 10 can thereby be obtained.

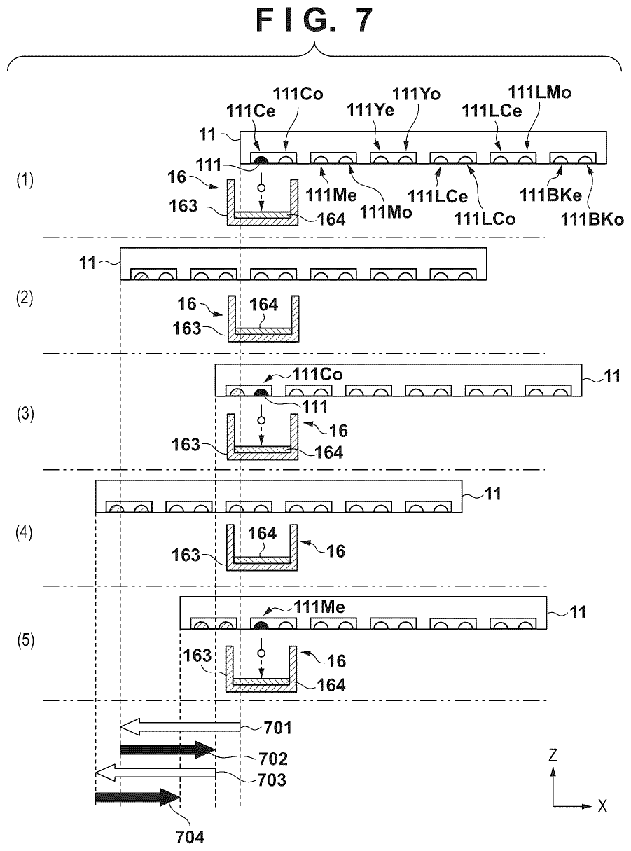

FIG. 7 will be referred to here. FIG. 7 is a diagram for describing movement control of the carriage 10 during discharge inspection executed by the liquid discharge apparatus 1. FIG. 7 is also a diagram for describing the discharge inspection processing of step S602 in FIG. 6 described above, for example. Also, FIG. 7 illustrates an example of movement control of the carriage 10 in the case of the liquid discharge apparatus 1 executing discharge inspection of the discharge head 11. Note that movement control of the carriage 10 may also be similarly performed at the time of discharge inspection of the discharge head 12, for example.

(1) of FIG. 7 shows a state in which the liquid discharge apparatus 1 is executing discharge inspection of the discharge port column 111C of the discharge head 11. First, as shown in (1) of FIG. 7, discharge port columns 111Ce to 111BKo each consisting of two columns, namely, an even column and an odd column, are disposed for the respective ink colors in the discharge head 11. Here, the discharge port columns 111C to 111BK for the respective ink colors may be described by distinguishing between the even column and the odd column. For example, the even column of the discharge port column 111C for cyan ink may be referred to as discharge port column 111Ce, and the odd column of the discharge port column 111C may be referred to as discharge port column 111Co. Note that this similarly applies to the discharge port columns 111M to 111BK.

For example, when the inspection area 1600 of the inspection unit 16 is changed to be smaller, or when the interval between the even column and the odd column is narrow, the inspection unit 16 is not able to perform discharge inspection of the even and odd columns at the same time. Accordingly, in the present embodiment, the liquid discharge apparatus 1 regards the even column and the odd column as separate discharge port columns when performing discharge inspection. Note that, in FIG. 7, the discharge port column that is undergoing discharge inspection is indicated by a black semicircle, and discharge port columns that have undergone discharge inspection are indicated by hashed semicircles. Also, in FIG. 7, discharge port columns that have yet to undergo discharge inspection are indicated by white semicircles.

(1) of FIG. 7 shows a state in which the liquid discharge apparatus 1 is executing discharge inspection of the discharge port column 111Ce. The liquid discharge apparatus 1 moves the carriage 10 to move the discharge port column 111Ce of the discharge head 11 to a position (inspection position) opposing the inspection unit 16. Also, in (1) of FIG. 7, the liquid discharge apparatus 1 discharges ink droplets from the discharge port column 111Ce and performs discharge inspection of the discharge ports 111 of the discharge port column 111Ce using the inspection unit 16. Ink droplets are discharged from the discharge ports 111 into a housing unit 163 of the inspection unit 16. The housing unit 163 is, for example, a box-shaped member that houses ink and reaction solution that has been used in discharge inspection. That is, the housing unit 163 is a waste liquid tank. Also, the housing unit 163 has an opening at the top, and is able to internally house (store) liquid that is discharged from the discharge heads 11 and 12. Also, the housing unit 163 is provided with an absorbent 164 that absorbs the ink and reaction solution discharged in the discharge inspection. The absorbent 164 is, for example, a spongy or porous member.

When discharge inspection on all the discharge ports 111 in the discharge port column 111Ce has ended, the liquid discharge apparatus 1 moves the carriage 10 to a position at which the discharge port column 111Co, which is the next inspection target, opposes the inspection unit 16. However, the interval between the discharge port column 111Ce and the discharge port column 111Co is narrow and may be less than the minimum movement distance. In such a case, the liquid discharge apparatus 1 is not able to move the carriage 10 from the inspection position of the discharge port column 111Ce to the inspection position of the discharge port column 111Co at one time.

Accordingly, in the present embodiment, the liquid discharge apparatus 1 temporarily moves the carriage 10 in the direction indicated by arrow 701 to a position further away than the minimum movement distance of the carriage 10. In the following description, the position further away than the minimum movement distance of the carriage 10 may be referred to as a reversal position. The reversal position is a position at which the distance between the discharge port column next targeted for inspection and the inspection position of the discharge port column next targeted for inspection is greater than or equal to the minimum movement distance.

(2) of FIG. 7 shows a state in which the liquid discharge apparatus 1 has moved the carriage 10 in the direction indicated by the arrow 701 to the reversal position.

In the present embodiment, the liquid discharge apparatus 1 moves the carriage 10 to the reversal position, each time discharge inspection on the discharge column targeted for inspection ends. The liquid discharge apparatus 1 then reverses the movement direction of the carriage 10 at the reversal position and moves the carriage 10 to the inspection position.

(3) of FIG. 7 shows a state in which the liquid discharge apparatus 1 has moved the carriage 10 from the reversal position shown in (2) of FIG. 7 to a position at which the discharge port column 111Co and the inspection unit 16 oppose each other and is performing discharge inspection of the discharge port column 111Co.

(4) of FIG. 7 shows a state in which the liquid discharge apparatus 1 has moved the carriage 10 to the reversal position, after ending discharge inspection on all the discharge ports 111 in the discharge port column 111Co in the state shown in (3) of FIG. 7.

(5) of FIG. 7 shows a state in which the liquid discharge apparatus 1 has moved the carriage 10 from the reversal position shown in (4) of FIG. 7 to a position at which the discharge port column 31Me and the inspection unit 16 oppose each other and is performing discharge inspection.

Thereafter, the liquid discharge apparatus 1 repeatedly executes discharge inspection and movement of the carriage 10 in order to perform discharge inspection, on each of the discharge port columns 31Me to 31Bko for which discharge inspection has not been implemented, similarly to the operation described above. In this way, the liquid discharge apparatus 1 is able to enhance the inspection accuracy, by temporarily moving the carriage 10 to the reversal position during discharge inspection of the discharge port columns.

Note that, in the present embodiment, a mode in which discharge inspection is performed in order of adjacent discharge port columns (e.g., discharge port column 111Ce followed by discharge port column 111Co) is described as an example, but the present invention is not limited thereto. For example, when the carriage 10 has been moved to the reversal position, the liquid discharge apparatus 1 may perform discharge inspection of the discharge port column located at the reversal position.

Deposition within Inspection Unit

The liquid discharge apparatus 1 in the present embodiment is capable of discharging a plurality of types of liquid. Specifically, for example, as described above, the liquid discharge apparatus 1 is capable of discharging ink and a reaction solution that reacts with the ink. The liquid discharge apparatus 1 is able to increase the viscosity of the ink by, for example, discharging the ink and the reaction solution. By increasing the viscosity of the ink, issues such as beading and bleeding of the ink on the printing medium 2 caused by the type of printing medium 2 can be suppressed, for example.

Also, the liquid discharge apparatus 1 performs discharge inspection for inspecting the discharge state of the discharge head 11 and the discharge head 12 at times such as during the recovery operation as described above. The liquid discharge apparatus 1 inspects the discharge state of the discharge head 11 and the discharge state of the discharge head 12 with the same inspection unit 16. In this way, by inspecting the discharge state of the discharge heads 11 and 12 with the same inspection unit 16, it is, for example, possible to save space inside the liquid discharge apparatus 1 and to lower the cost of the liquid discharge apparatus 1, compared to when the inspection unit 16 is provided for each of the discharge heads 11 and 12.

Incidentally, ink and reaction solution that have been used in discharge inspection are housed in the housing unit 163 as described above. In the following description, ink and reaction solution used in discharge inspection may be referred to as waste liquid. For example, the ink and reaction solution housed in the housing unit 163 may react, and the colorant contained in the ink may aggregate. The colorant is, in other words, a pigment. Since the liquid discharge apparatus 1 discharges ink and reaction solution so as to pass through the inspection area 1600 of the inspection unit 16 in the discharge inspection, ink and reaction solution can accumulate in a predetermined place inside the housing unit 163. For example, aggregates of colorant are deposited when ink and reaction solution accumulate in a predetermined place inside the housing unit 163.

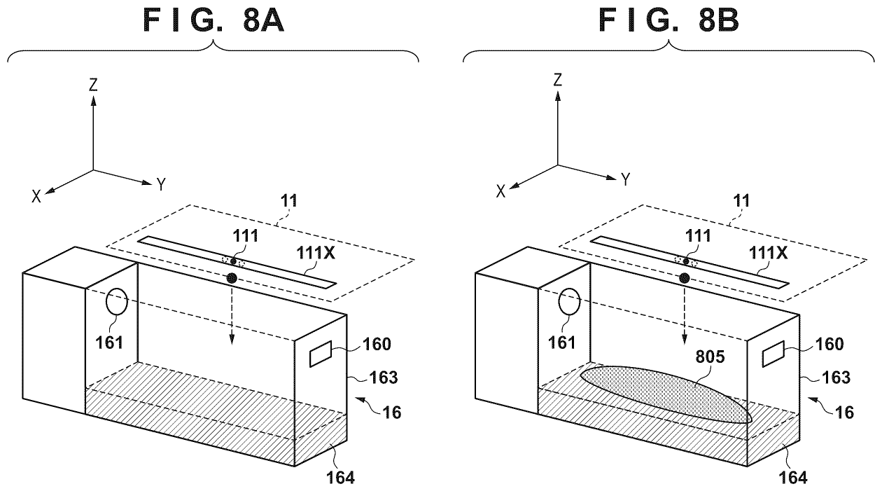

Here, deposition of aggregates of the colorant that has been used in discharge inspection inside the housing unit 163 will be described, with reference to FIGS. 8A and 8B.

FIG. 8A will be referred to first. FIG. 8A is a diagram illustrating the internal state of the housing unit 163, for example. As shown in FIG. 8A, ink droplets discharged from a predetermined nozzle column 111X of the discharge head 11 pass between the light emitting element 161 and the light receiving element 160 and land inside the housing unit 163 of the inspection unit 16. Also, the liquid discharge apparatus 1 repeated performs discharge inspection as described above on each discharge port column and discharge port, and, after being discharged, the ink droplets are stored inside the housing unit 163 as waste liquid. Also, as described above, the absorbent 164 is provided inside the housing unit 163, and the waste liquid is absorbed by the absorbent 164.

Note that, in the present embodiment, a configuration in which the light emitting element 161 and the light receiving element 160 are integrally provided in the housing unit 163 is described as an example, but the present invention is not limited thereto. For example, the light emitting element 161 and the light receiving element 160 may be provided in such a manner as to be separable from the housing unit 163. That is, the liquid discharge apparatus 1 may have the inspection unit 16 having the light emitting element 161 and the light receiving element 160, and the housing unit 163 that is separable from the inspection unit 16.

For example, when waste liquid accumulates inside the discharge housing unit 163, the waste liquid blocks the space between the light emitting element 161 and the light receiving element 160, and discharge inspection can no longer be implemented. Thus, the liquid discharge apparatus 1 manages the replacement timing of the inspection unit 16. Specifically, for example, the liquid discharge apparatus 1 manages the amount of ink or reaction solution discharged inside the inspection unit 16 as a dot count, and, when a value prescribed in advance is exceeded, notifies that the inspection unit 16 needs to be replaced. For example, the liquid discharge apparatus 1 may display a message indicating that the inspection unit 16 needs to be replaced on a display unit (not shown) of the liquid discharge apparatus 1. Also, for example, the liquid discharge apparatus 1 may transmit a notification indicating that the inspection unit 16 needs to be replaced to a provider (vendor) of the liquid discharge apparatus 1.

For example, it is sought to reduce the replacement frequency of the inspection unit 16 in order to improve convenience to the user who utilizes the liquid discharge apparatus 1. The replacement frequency of the inspection unit 16 can, in other words, also be said to be the life of the inspection unit 16. It is envisaged that, for example, increasing the amount of waste liquid that the housing unit 163 is capable of housing will extend the life of the inspection unit 16. Specifically, for example, it is conceivable to increase the amount of waste liquid that can be housed by increasing the bottom area or height of the housing unit 163.

FIG. 8B will be referred to here. FIG. 8B is a diagram illustrating the internal state of the inspection unit 16 when the liquid discharge apparatus 1 repeatedly performs discharge inspection of the discharge head 11 and the discharge head 12.

When discharge inspection of the discharge heads 11 and 12 is performed by the same inspection unit 16, the discharged ink and reaction solution react inside the housing unit 163 and aggregation of the colorant occurs. When discharge inspection of only the ink is performed (see FIG. 8A), the discharged ink spreads over the entire bottom surface of the housing unit 163 and is absorbed by the absorbent 164. However, when discharge inspection of the discharge heads 11 and 12 is performed, aggregates 805 of colorant formed by the ink reacting with the reaction solution and aggregating are deposited inside the housing unit 163 and are not absorbed by the absorbent 164.

Accordingly, it is thought that the life of the inspection unit 16 cannot be extended by only increasing the bottom area of the housing unit 163, in the case of performing discharge inspection of the discharge heads 11 and 12 with the same inspection unit 16. Also, in the case where the height of the housing unit 163 is increased and the distance between the absorbent 164 and the elements 160 and 161 is extended, there is an increased possibility that the ink or reaction solution discharged during discharge inspection will form a suspended mist that is suspended in the air and unable to land on the absorbent 164. When the suspended mist adheres to the elements 160 and 161, the inspection accuracy can decrease due to soiling by the suspended mist.

As described above using FIGS. 8A and 8B, when discharge inspection of the discharge heads 11 and 12 is implemented with the same inspection unit 16, the aggregates 805 formed by the colorant in the ink reacting with the reaction solution and aggregating are deposited. Deposition of the aggregates 805 shortens the life of the inspection unit 16. Accordingly, a way of suppressing aggregation of the colorant and extending the life of the inspection unit 16 even when discharge inspection of the discharge heads 11 and 12 is implemented with the same inspection unit 16 needs to be devised.

In the present embodiment, the liquid discharge apparatus 1 controls discharge of the discharge heads 11 and 12, such that the reaction between the ink and the reaction solution is suppressed during discharge inspection. In the present embodiment, the liquid discharge apparatus 1, specifically, for example, controls discharge of the discharge heads 11 and 12, such that the reaction solution is discharged before the ink during discharge inspection. Adopting such a mode enables aggregation of the colorant to be suppressed and the life of the inspection unit 16 to be extended, even when discharge inspection of the discharge heads 11 and 12 is implemented inside the same inspection unit 16.

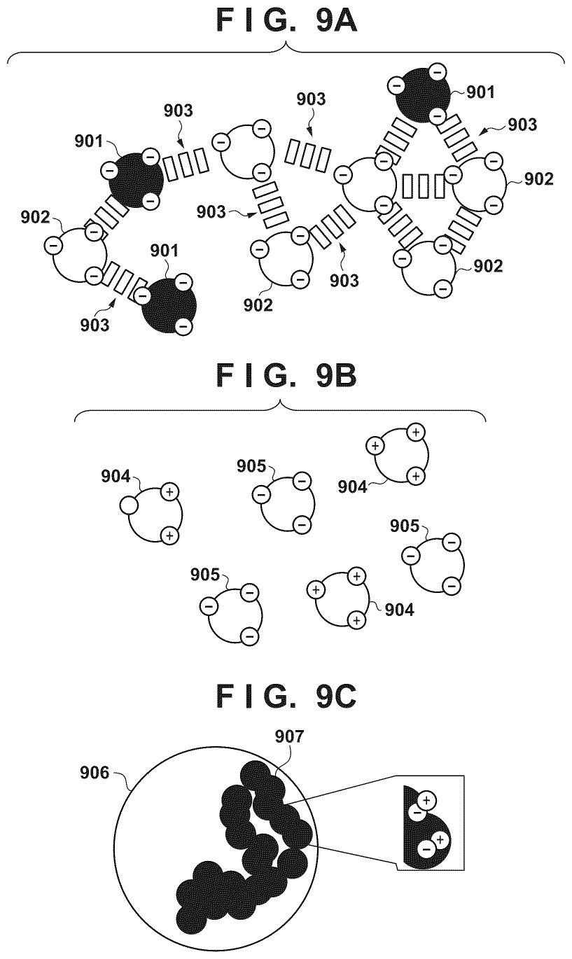

Hereinafter, description of the reaction between the ink and the reaction solution will be given, followed by detailed description of discharge inspection of the present embodiment. First, the reaction between the ink and the reaction solution will be described. FIGS. 9A to 9C will now be referred to. FIGS. 9A to 9C are diagrams for describing aggregation of the colorant caused by the ink reacting with the reaction solution.

First, FIG. 9A is a schematic diagram for describing the state of the ink before reacting with the reaction solution. The ink in the present embodiment includes, for example, colorant 901 and emulsion 902 as described above. In the ink before reacting with the reaction solution, the colorant 901 and the emulsion 902 are dispersed. Specifically, for example, the colorant 901 and the emulsion 902 are dispersed in the ink in an anionic state. That is, the colorant 901 and the emulsion 902 repulse each other due to the repulsive force of negative charge. Also, the colorant 901 and the emulsion 902 are also dispersed by a repulsive force 903 (steric hindrance) of physical structures.

Next, FIG. 9B shows the dispersed state of the reaction solution before reacting with the ink. In the present embodiment, magnesium ions 904 in a positively charged cationic state and sulfate ions 905 in a negatively charged anionic state are ionized and dispersed in the reaction solution.

For example, when the ink and the reaction solution mix inside the inspection unit 16 due to discharge inspection being implemented by the liquid discharge apparatus 1, anions present in the ink and cations present in the reaction solution react and charge is lost. The dispersion of the colorant 901 and the emulsion 902 is thereby destroyed, and aggregation of the colorant 901 occurs. Note that the cohesive force within the reaction solution is higher as the concentration of cations in the reaction solution increases, and the aggregate viscosity of the liquid mixture of ink and reaction solution tends to be higher as the concentration of anions within the ink increases. The aggregate viscosity is, for example, the viscosity of the liquid mixture obtained after mixing the ink with the reaction solution.

Also, simply because cations are present in the reaction solution does not always mean that the ink will react with the reaction solution and aggregate, and, for example, the concentration of cations needs to be high enough to destroy the steric hindrance 903.

FIG. 9C is a schematic diagram for describing the state after the ink is mixed with the reaction solution. When the ink is mixed with the reaction solution, non-aggregates 906 and aggregates 907 occur. The non-aggregates 906 contain a liquid component such as water and solvent of the ink or reaction solution. Also, the aggregates 907 contain reactively aggregated colorant 901 and emulsion 902.

In this way, as described using FIGS. 9A to 9C, when ink and reaction solution are mixed, the aggregates 907 occur. The state of the aggregates 907 may differ, depending on, for example, the order in which the inks are mixed with the reaction solution and the concentration of the colorant 901 contained in the ink. That is, the state of the aggregates 907 may differ, depending on the reactivity between the ink and the reaction solution.

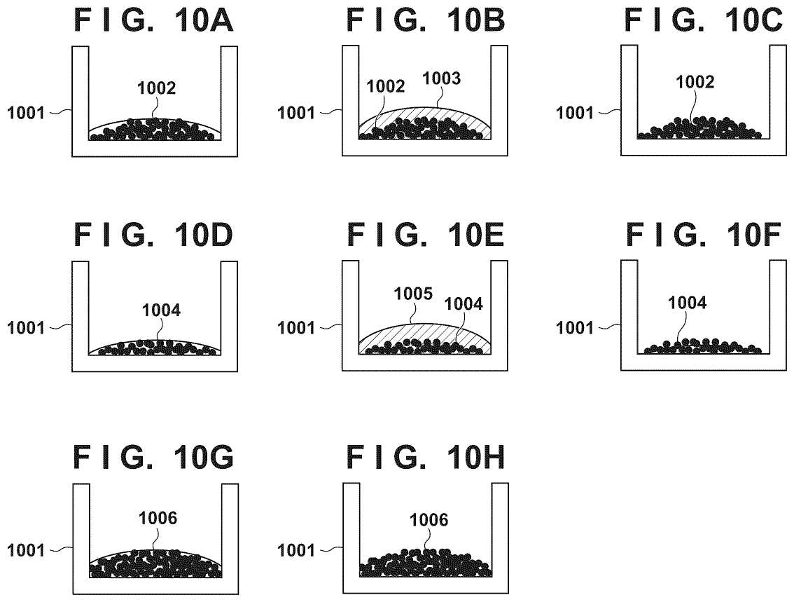

Here, an example of cases in which the state of the aggregates 907 differs depending on the reactivity of the ink and the reaction solution will be described, with reference to FIGS. 10A to 10H. FIGS. 10A to 10H are diagrams for describing that the deposition height of the aggregates differs, depending on the reactivity between the ink and the reaction solution inside the inspection unit 16. A box 1001 is, for example, a box-shaped member envisioned on the inspection unit 16, and the upper surface of the box 1001 is open similarly to the inspection unit 16. In the present embodiment, the behavior of the reactive aggregate when various types of ink are mixed in equal amounts inside the box 1001 envisioned on the inspection unit 16 was confirmed.

FIG. 10A shows the state inside the box 1001 in the case where reaction solution and cyan ink are mixed in the stated order inside in the box 1001. Deposits 1002 schematically represent the state after the cyan ink reacts with the reaction solution and aggregates. Note that the individual clumps of deposits shown in FIGS. 10A to 10H do not represent individual colorant particles, and are aggregates of a certain size that contain colorant and emulsion. That is, immediately after the cyan ink reacts with the reaction solution, liquid such as water/solvent also remains inside the box 1001. There is a void between the deposits 1002, and water/solvent is also present in this void. Also, even after the water/solvent has evaporated over time, the void between the deposits 1002 is not filled and will not become smooth, and the height of the deposits 1002 is maintained.

FIG. 10B shows the state inside the box 1001 when light cyan ink is mixed in after the state of FIG. 10A. Light cyan ink 1003 wets and spreads inside the box 1001 without further depositing on the deposits 1002. This is presumed to be because the concentration of cations in the reaction solution has decreased due to the reaction between the cyan ink and the reaction solution in FIG. 10A, and the reaction solution is no longer sufficiently cationic to overcome the steric hindrance as illustrated in FIGS. 9A to 9C.

FIG. 10C shows the state inside the box 1001 when evaporation of water and/or solvent has proceeded after the state of FIG. 10B. The colorant contained in the unreacted cyan ink and light cyan ink that has not reacted with the reaction solution wets and spreads inside the box 1001, and, thereafter, evaporation of water and/or solvent proceeds, and a sediment forms on the bottom surface of the box 1001.

FIG. 10D shows the state inside the box 1001 in the case where reaction solution and light cyan ink are mixed in the stated order inside the box 1001. Deposits 1004 schematically represent the state after the light cyan ink has reacted with the reaction solution and aggregated. Since light cyan ink contains a smaller amount of colorant compared to cyan ink, the height of the deposits 1004 is lower when compared to the deposits 1002 shown in FIG. 10A which occurred due to aggregation of the cyan ink.

FIG. 10E shows the state inside the box 1001 in the case where cyan ink is mixed in after the state of FIG. 10D. Cyan ink 1005 wets and spreads inside the box 1001 without depositing on the deposits 1004 due to aggregation reaction. This is presumed to be because the concentration of cations in the reaction solution has decreased due to the light cyan ink having reacted with the reaction solution, and the reaction solution is no longer sufficiently cationic to overcome the steric hindrance.

FIG. 10F shows the state inside the box 1001 when evaporation of water and/or solvent proceeds after the state of FIG. 10E. The colorant contained in the unreacted cyan ink and light cyan ink that has not reacted with the reaction solution wets and spread inside the box 1001, and, thereafter, evaporation of water and/or solvent proceeds and a sediment forms on the bottom surface of the box 1001.

As illustrated in FIGS. 10A to 10C and 10D to 10F described above, the aggregates of both the deposits 1002 and the deposits 1004 contain unreacted colorant, and it is possible for this colorant to wet and spread on the bottom surface of the box 1001. On the other hand, the height of the deposits 1004 inside the box 1001 is lower than the deposits 1002. This is presumed to be because, in FIGS. 10D to 10F, the light cyan ink was introduced to the box 1001 before the cyan ink, after first introducing the reaction solution. Light cyan ink has a lower concentration of colorant than cyan ink. That is, due to the light cyan ink being introduced into the box 1001 before the cyan ink, the amount of colorant reacting with the reaction solution is smaller. Also, since the concentration of cations in the reaction solution decreases due to the reaction between the light cyan ink and the reaction solution, it can also be said that the reactivity inside the box 1001 is low. It is surmised that the deposits 1004 was lower than the deposits 1002 for this reason.

FIG. 10G shows the state inside the box 1001 when cyan ink, light cyan ink, and the reaction solution are mixed in the stated order inside the box 1001. The height of deposits 1006 that occur due to the cyan ink and light cyan ink reacting with the reaction solution is larger than the deposits 1002 in FIG. 10A and the deposits 1004 in FIG. 10D. This is presumed to be because the amount of ink reacting with the reaction solution is larger compared to when the ink is introduced to the box 1001 after first introducing the reaction solution (FIGS. 10A and 10D). Specifically, for example, it is presumed that, when the colorant aggregates, the height of the deposits 1006 will be greater as the amount of the colorant increases as shown in FIG. 10G, since the aggregates also contain unreacted colorant.

FIG. 10H shows the state inside the box 1001 when evaporation of water and/or solvent has proceeded after the state of FIG. 10G. Although the state of the deposits 1006 after the evaporation of water/solvent has progressed is shown, the height of the deposits themselves is maintained as described above, and thus the height of the deposits 1006 is the highest compared to the deposits 1002 and the deposits 1004.

Given the above tendencies, when mixing ink and reaction solution, deposition of aggregates can be suppressed, by introducing the reaction solution into the box 1001 first, and then introducing the ink. That is, in the discharge inspection described above, the reaction of the reaction solution and the ink can be suppressed inside the inspection unit 16 (i.e., housing unit 163), by discharging the reaction solution from the discharge head 12 and then discharging the ink from the discharge head 11 and implementing discharge inspection.

Furthermore, as described above, the inspection unit 16 is provided with the absorbent 164. That is, the liquid discharge apparatus 1 is able to allow the reaction solution to penetrate the absorbent 164, by discharging the reaction solution first and implementing discharge inspection. It is thereby possible to suppress the contact between the reaction solution discharged first and the ink discharged after the reaction solution.

Note that, in order to simplify description, the present embodiment is illustrated and described as suppressing aggregation by introducing ink such as light cyan ink and cyan ink after the reaction solution, but, strictly speaking, adopting this approach does not completely prevent the reaction between the reaction solution and the inks, and the inks can react with the reaction solution and aggregate to some extent. However, as described using FIGS. 10A to 10H, the relationship between the order in which the liquids (reaction solution, ink) are introduced and the height of the deposits does not change.

### Discharge Inspection Processing

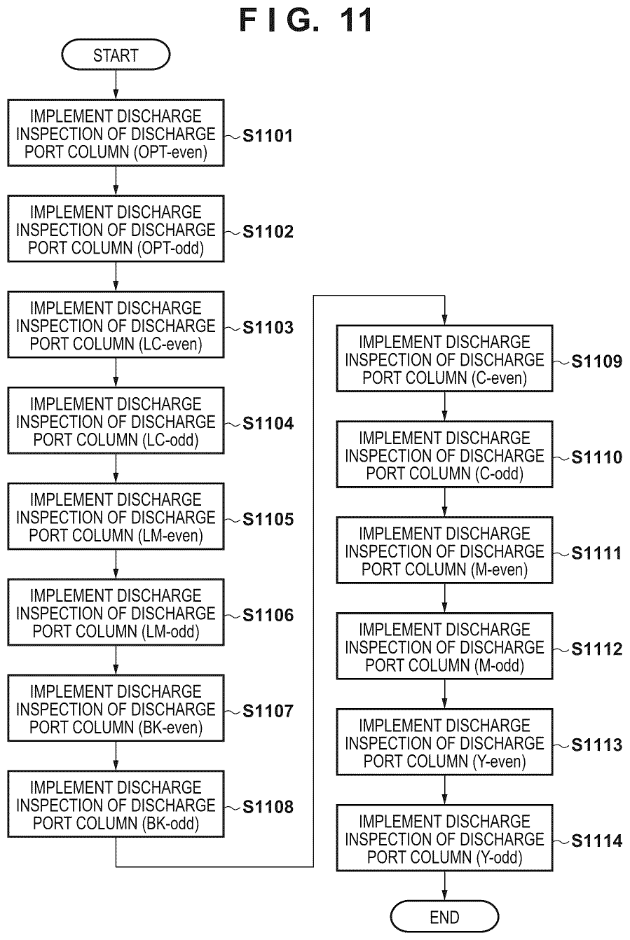

FIG. 11 is a flowchart showing an example of discharge inspection processing that is executed by the liquid discharge apparatus 1 of the present embodiment. The processing of FIG. 11 that is executed by the liquid discharge apparatus 1 is realized by, for example, a control program stored in a memory such as the ROM 171 being unpacked in the RAM 172 and executed by the CPU 170. Also, for example, the processing of FIG. 11 corresponds to the processing that is executed in step S602 of FIG. 6, for example.

In step S1101, the liquid discharge apparatus 1 performs control for moving the discharge port column OPT-even targeted for inspection among the discharge port columns of the discharge head 12 to the upper part of the inspection unit 16, for example. Specifically, for example, the liquid discharge apparatus 1 controls the movement mechanism 13 to move the discharge port column OPT-even to the upper part of the inspection unit 16. Also, in step S1101, the liquid discharge apparatus 1 controls the inspection unit 16 to be in a state in which inspection is possible. For example, the liquid discharge apparatus 1 may perform control to irradiate light from the light emitting element 161. In step S1101, the liquid discharge apparatus 1 then discharges the reaction solution from the discharge ports 121 of the discharge port column OPT-even targeted for inspection and executes discharge inspection of the discharge ports 121 with the inspection unit 16.

In the following description, the case where, after controlling the inspection unit 16 to be in a state in which inspection is possible in step S1101, the liquid discharge apparatus 1 controls the inspection unit 16 to maintain the state in which inspection is possible until the processing of FIG. 11 ends will be given as an example. Note that the liquid discharge apparatus 1 may control the inspection unit 16 to maintain the state in which inspection is possible throughout the respective processing of steps S1101 to S1114, for example.

Also, in the following description, in the respective processing of steps S1102 to S1114, control for moving the discharge port column targeted for inspection to the upper part of the inspection unit 16 is executed by the liquid discharge apparatus 1 driving the movement mechanism 13 in a similar manner to step S1101, and thus redundant description will be omitted.

Also, in the respective processing of steps S1101 to S1114 in FIG. 11, the liquid discharge apparatus 1 controls the carriage 10 to move to the reversal position as described above, in order to move the discharge port column targeted for inspection to the upper part of the inspection unit 16, and description thereof will be omitted here.

Also, the discharge port column OPT-even is the even column of the discharge port column OPT. Hereinafter, discharge port columns will be described by distinguishing between the even column and the odd column.

In step S1102, the liquid discharge apparatus 1 moves the discharge port column OPT-odd targeted for inspection among the discharge port columns of the discharge head 12 to the upper part of the inspection unit 16, and then discharges the reaction solution from the discharge ports 121 and executes discharge inspection of the discharge ports 121, for example.

In this way, in the present embodiment, the liquid discharge apparatus 1 inspects the discharge state of the discharge head 12 before the discharge head 11. That is, the liquid discharge apparatus 1 performs control to discharge the reaction solution from the discharge head 12 first in the discharge inspection and execute discharge inspection. The ink reacting with the reaction solution inside the inspection unit 16 and aggregating can thereby be suppressed.

In step S1103, the liquid discharge apparatus 1 moves the discharge port column LC-even targeted for inspection among the discharge port columns of the discharge head 11 to the upper part of the inspection unit 16, and then discharges light cyan ink from the discharge ports 111 and executes discharge inspection of the discharge ports 111, for example.

In step S1104, the liquid discharge apparatus 1 moves the discharge port column LC-odd targeted for inspection among the discharge port columns of the discharge head 11 to the upper part of the inspection unit 16, and then discharges light cyan ink from the discharge ports 111 and executes discharge inspection of the discharge ports 111, for example.

In the present embodiment, the liquid discharge apparatus 1, in steps S1103 and 1104, discharges light cyan ink from the discharge head 11 and performs discharge inspection of the discharge port columns (LC-even, LC-odd). In the present embodiment, light cyan ink has the lowest concentration of colorant among the plurality of color inks, as shown in Table 1. That is, light cyan ink is the ink with the least amount of colorant that reacts with the reaction solution. In this way, in the present embodiment, the liquid discharge apparatus 1 discharges the reaction solution in step S1101, and then discharges the ink with the lowest concentration of colorant among the plurality of types of color ink and performs discharge inspection. The reaction solution and the ink reacting inside the inspection unit 16 and aggregates being generated can thereby be suppressed.

In step S1105, the liquid discharge apparatus 1 moves the discharge port column LM-even targeted for inspection among the discharge port columns of the discharge head 11 to the upper part of the inspection unit 16, and then discharges light magenta ink from the discharge ports 111 and executes discharge inspection of the discharge ports 111, for example.

In step S1106, the liquid discharge apparatus 1 moves the discharge port column LM-odd targeted for inspection among the discharge port columns of the discharge head 11 to the upper part of the inspection unit 16, and then discharges light magenta ink from the discharge ports 111 and executes discharge inspection of the discharge ports 111, for example.

In the present embodiment, the liquid discharge apparatus 1, in steps S1105 and S1106, performs discharge inspection of the discharge port columns (LM-even, LM-odd) of light magenta ink, which has the second lowest concentration of colorant among the plurality of types of color ink.

In step S1107, the liquid discharge apparatus 1 moves the discharge port column BK-even targeted for inspection among the discharge port columns of the discharge head 11 to the upper part of the inspection unit 16, and then discharges black ink from the discharge ports 111 and executes discharge inspection of the discharge ports 111, for example.

In step S1108, the liquid discharge apparatus 1 moves the discharge port column BK-odd targeted for inspection among the discharge port columns of the discharge head 11 to the upper part of the inspection unit 16, and then discharges black ink from the discharge ports 111 and executes discharge inspection of the discharge ports 111, for example.

In the present embodiment, the liquid discharge apparatus 1, in steps S1107 and S1108, performs discharge inspection of the discharge port columns (BK-even, BK-odd) of black ink, which has the third lowest concentration of colorant among the plurality of types of color ink.

In step S1109, the liquid discharge apparatus 1 moves the discharge port column C-even targeted for inspection among the discharge port columns of the discharge head 11 to the upper part of the inspection unit 16, and then discharges cyan ink from the discharge ports 111 and executes discharge inspection of the discharge ports 111, for example.

In step S1110, the liquid discharge apparatus 1 moves the discharge port column C-odd targeted for inspection among the discharge port columns of the discharge head 11 to the upper part of the inspection unit 16, and then discharges cyan ink from the discharge ports 111 and executes discharge inspection of the discharge ports 111, for example.

In the present embodiment, the liquid discharge apparatus 1, in steps S1109 and S1110, performs discharge inspection of the discharge port columns (C-even, C-odd) of cyan ink, which has the fourth lowest concentration of colorant among the plurality of types of color ink.

In step S1111, the liquid discharge apparatus 1 moves the discharge port column M-even targeted for inspection among the discharge port columns of the discharge head 11 to the upper part of the inspection unit 16, and then discharges magenta ink from the discharge ports 111 and executes discharge inspection of the discharge ports 111, for example.

In step S1112, the liquid discharge apparatus 1 moves the discharge port column M-odd targeted for inspection among the discharge port columns of the discharge head 11 to the upper part of the inspection unit 16, and then discharges magenta ink from the discharge ports 111 and executes discharge inspection of the discharge ports 111, for example.

In the present embodiment, the liquid discharge apparatus 1, in steps S1111 and S1112, performs discharge inspection of the discharge port columns (M-even, M-odd) of magenta ink, which has the fifth lowest concentration of colorant among the plurality of types of color ink.

In step S1113, the liquid discharge apparatus 1 moves the discharge port column Y-even targeted for inspection among the discharge port columns of the discharge head 11 to the upper part of the inspection unit 16, and then discharges yellow ink from the discharge ports 111 and executes discharge inspection of the discharge ports 111, for example.

In step S1114, for example, the liquid discharge apparatus 1 moves the discharge port column Y-odd targeted for inspection among the discharge port columns of the discharge head 11 to the upper part of the inspection unit 16, and then discharges yellow ink from the discharge ports 111 and executes discharge inspection of the discharge ports 111, for example.

In the present embodiment, the liquid discharge apparatus 1, in step S1113 and step S1114, performs discharge inspection of the discharge port columns (Y-even, Y-odd) of yellow ink, which has the highest concentration of colorant among the plurality of types of color ink.

In this way, according to the present embodiment, the liquid discharge apparatus 1 discharges the reaction solution from the discharge head 12 first in the discharge inspection. After discharge inspection of the discharge head 12, the liquid discharge apparatus 1 performs control to discharge a plurality of types of color ink from the discharge head 11 in ascending order of colorant concentration and execute discharge inspection. The ink reacting to the reaction solution inside the inspection unit 16 and depositing can thereby be suppressed.

Note that, in the respective processing of steps S1101 to S1114 in FIG. 11, the liquid discharge apparatus 1 may, for example, discharge one droplet of ink or reaction solution from the discharge ports targeted for inspection or may discharge several droplets of ink or reaction solution. Also, in the case of discharging several droplets of ink or reaction solution, the liquid discharge apparatus 1 may discharge the droplets of ink continuously or discontinuously. Also, in the present embodiment, the liquid discharge apparatus 1 performs control to discharge the reaction solution first, and then discharge the plurality of types of color ink from the discharge head 11 in ascending order of colorant concentration, but the present invention is not limited thereto. For example, the discharge order of the plurality of types of color ink may be determined, based on the concentration of cations in the reaction solution. For example, when discharge inspection is repeatedly performed after discharging the reaction solution, the concentration of cations in the reaction solution decreases. Accordingly, the liquid discharge apparatus 1 may discharge the plurality of types of color ink in ascending order of colorant concentration after first discharging the reaction solution in the discharge inspection, and, if the cation concentration of the reaction solution and the ink inside the inspection unit decreases to a predetermined concentration, the discharge order of the remaining inspection targets of the discharge head 11 need not be ascending order of colorant concentration.

Note that, in the present embodiment, the case where the plurality of types of color ink are each adjusted to a different concentration of colorant is described as an example, but the plurality of types of color ink may, for example, also include inks with equal concentrations of colorant. When inks with equal concentrations of colorant are used in this way, discharge inspection may, for example, be implemented in ascending order of aggregate viscosity. For example, even if the concentration of colorant is the same, the reactivity (degree of aggregation) of the ink and the reaction solution differs depending on the type of dispersion or colorant. Accordingly, the liquid discharge apparatus 1 may perform discharge inspection in such a manner as to discharge inks having lower reactivity to the reaction solution before inks having higher reactivity. Specifically, discharge inspection may be implemented in such a manner as to discharge inks having lower aggregate viscosities before inks having higher aggregate viscosities. For example, before implementing discharge inspection, a plurality of types of color ink having equal concentrations of colorant may each be mixed with the reaction solution using a viscometer or the like, and the aggregate viscosity may be measured. Also, a control program for executing discharge inspection that is based on the measurement result may be stored in a memory such as the ROM 171. Note that the aggregate viscosity is the viscosity of the liquid mixture when the ink and the reaction solution have been mixed together. That is, the aggregate viscosity can also be said to be a mixed viscosity.

Also, the discharge head 12 is not limited to discharging one type of reaction solution and may discharge a plurality of types of reaction solution. The plurality of types of reaction solution may, for example, be reaction solutions having different cation concentrations. Also, the discharge head 12 may be provided with a discharge port column for each of the plurality of types of reaction solution. Also, even in the case where the discharge head 12 discharges a plurality of types of reaction solution, the liquid discharge apparatus 1 is able to control the deposition of aggregates inside the inspection unit 16, by implementing discharge inspection of the discharge head 12 before the discharge head 11. Also, in the case where the plurality of reaction solutions include a first reaction solution that reacts with the colorant of color ink and a second reaction solution that aggregates the colorant more than the first reaction solution, the liquid discharge apparatus may perform discharge inspection in such a manner as to discharge the second reaction solution before the first reaction solution. For example, prior to discharge inspection, the plurality of reaction solutions and color inks may be mixed and the degree of aggregation of the colorant or the like may be observed. Also, a control program for executing discharge inspection that is based on the observation result may be stored in a memory such as the ROM 171.

### Second Embodiment

Hereinafter, a second embodiment will be described in terms of the differences from the first embodiment. In the first embodiment, a mode is described in which the liquid discharge apparatus 1, in the discharge inspection, discharges the reaction solution before the ink, such that the reaction between the ink and the reaction solution is suppressed, and inspects the discharge state of discharge heads 11 and 12. In the present embodiment, a mode will be described in which the liquid discharge apparatus 1, in the discharge inspection, executes predetermined processing between each discharge of the reaction solution and the ink, such that the reaction between the ink and the reaction solution is suppressed. In this way, in the present embodiment, the reaction between the ink and the reaction solution inside the inspection unit 16 can be suppressed, by executing predetermined processing between each discharge of the reaction solution and the ink.

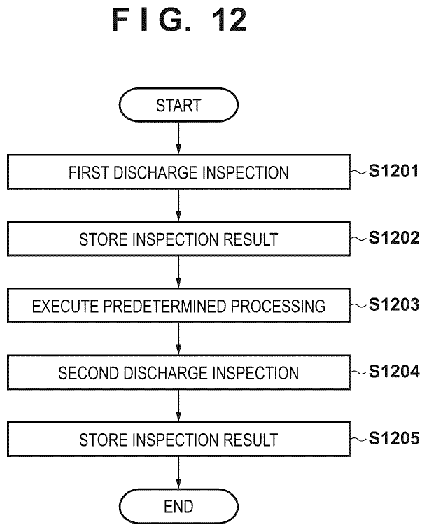

FIG. 12 is a flowchart showing an example of a series of processing relating to discharge inspection that is executed by the liquid discharge apparatus 1 of the present embodiment. The processing of FIG. 12 that is executed by the liquid discharge apparatus is realized, for example, by a control program stored in a memory such as ROM being unpacked in RAM and executed by a CPU.

The liquid discharge apparatus executes the processing of FIG. 12 at a predetermined timing, for example. In the present embodiment, the predetermined timing is, for example, before or after the liquid discharge apparatus 1 executes discharging onto the printing medium 2. In other words, the processing of FIG. 12 is executed before the start of printing or after the completion of printing. By executing the series of processing relating to discharge inspection at such a timing, the accuracy with which liquid is discharged onto the printing medium 2 can be enhanced, for example. That is, the quality of the printed matter can be enhanced.

In step S1201, the liquid discharge apparatus 1 executes first discharge inspection. The first discharge inspection may, for example, be discharge inspection of the discharge head 12. Here, the processing that is executed in step S1201 may, for example, be similar to the processing of steps S1101 and S1102.

In step S1202, the liquid discharge apparatus 1 stores the result of the discharge inspection of step S1201. For example, the liquid discharge apparatus 1 may store non-discharging nozzle information as the result of the discharge inspection. As the non-discharging nozzle information, information on discharge ports determined to have poor discharge in the processing of step S1201 may be stored, for example.

In step S1203, the liquid discharge apparatus 1 executes predetermined processing. For example, the liquid discharge apparatus 1 may discharge various types of ink and reaction solution from the discharge heads 11 and 12 onto the printing medium 2 as the predetermined processing. That is, in step S1203, the liquid discharge apparatus 1 may execute printing.

In step S1204, the liquid discharge apparatus 1 executes second discharge inspection. The second discharge inspection may, for example, be discharge inspection of the discharge head 11. Here, the processing that is executed in step S1201 may be similar to the processing of steps S1103 to S1114, for example.

In step S1205, the liquid discharge apparatus 1 stores the result of the discharge inspection of step S1204. For example, the liquid discharge apparatus 1 may store non-discharging nozzle information as the result of the discharge inspection. As the non-discharging nozzle information, information on discharge ports determined to have poor discharge in the processing of step S1204 may be stored, for example.

In this way, in the present embodiment, the liquid discharge apparatus 1 executes printing as the predetermined processing, between discharge inspection of the discharge head 12 and discharge inspection of the discharge head 11. By performing predetermined processing in this way, evaporation of the reaction solution discharged inside the inspection unit 16 by the discharge head 12 in the discharge inspection of step S1201 proceeds, for example. As described above, the reaction solution is ionized into cations and anions, and reactive aggregation occurs when the cations in the reaction solution come into contact with the anions in the ink. On the other hand, as the evaporation of water in the reaction solution proceeds, ionization of anions and cations in the reaction solution can no longer occur. That is, after the evaporation of water in the reaction solution has proceeded, the reactivity between the reaction solution and the ink decreases. Accordingly, by executing printing as the predetermined processing between discharge inspections, reaction between the ink and the reaction solution inside the inspection unit 16 can be suppressed.

Note that, in the present embodiment, the liquid discharge apparatus 1 executes discharge inspection of the discharge head 12 as the first discharge inspection of step S1201, and discharge inspection of the discharge head 11 as the second discharge inspection of step S1204, but the present invention is not limited thereto. For example, the liquid discharge apparatus 1 may execute discharge inspection of the discharge head 11 as the first discharge inspection in step S1201, and discharge inspection of the discharge head 12 as the second discharge inspection in step S1204. For example, in this way, even if ink is first discharged from the discharge head 11 in the first discharge inspection, predetermined processing is executed before the second discharge inspection, and thus the ink discharged in the first discharge inspection is able to wet and spread inside the inspection unit 16 and be absorbed by the absorbent 164. The reaction between the ink and the reaction solution inside the inspection unit 16 can thereby be suppressed.

Also, in the present embodiment, the case where the liquid discharge apparatus 1 executes printing as the predetermined processing in step S1203 is described as an example, but the present invention is not limited thereto. For example, the liquid discharge apparatus 1 may perform processing for counting a predetermined time as the predetermined processing in step S1203. By counting a predetermined time as the predetermined processing in this way, evaporation of the reaction solution or wetting and spreading of the ink is able to proceed inside the inspection unit 16. Also, the predetermined time may, for example, be determined according to the type or amount of liquid that is discharged inside the inspection unit 16 at the time of the first discharge inspection of step S1201.

### Third Embodiment

Hereinafter, a third embodiment will be described in terms of the differences from the first and second embodiments. In the first and second embodiments, the case where, in discharge inspection of the discharge head 11, six types of color ink, namely, cyan ink, magenta ink, yellow ink, black ink, light cyan ink, and light magenta ink, are discharged is described as an example. In the present embodiment, discharge inspection in the case where the above-described discharge head 11 is also capable of discharge clear ink in addition to the six types of color ink will be described.

Clear ink is, for example, used for the purpose of improving the fastness or glossiness of the printing medium 2. Also, clear ink does not contain colorant (pigment), and thus has a lower reactivity to the reaction solution compared to color inks.

Therefore, in the present embodiment, in the case where the discharge head 11 is capable of discharging clear ink, discharge inspection of the discharge head 11 is performed after discharge inspection of the discharge head 12. Furthermore, discharge inspection of the discharge port column of clear ink (not shown) is implemented before discharge inspection of the discharge port columns 111C to 111BK of the color inks. With such a mode, deposition of aggregates inside the inspection unit 16 can be suppressed, compared to the case where discharge inspection of the discharge port columns 111C to 111BK of the color inks is executed before the discharge port column of the clear ink (not shown).

Note that, as described above, the clear ink does not contain colorant. Thus, when the clear ink is mixed with the reaction solution, for example, the concentration of cations in the reaction solution is less likely to decrease than when a color ink is mixed with the reaction solution. Assume, for example, that after mixing the reaction solution and the clear ink together, a color ink is further mixed into this liquid mixture. In this case, the concentration of cations in the liquid mixture obtained by mixing the reaction solution and the clear ink may not necessarily be a concentration capable of suppressing the reaction with the color ink. Therefore, in the present embodiment, discharge inspection of the discharge head 11 is implemented such that discharge inspection of the discharge port column of the clear ink is implemented first, and then discharge inspection of the discharge port columns 111C to 111BK of the color inks is implemented in ascending order of colorant concentration. Reaction of the plurality of types of ink with the reaction solution inside the inspection unit 16 can thereby be suppressed.

### Clear Ink

Next, formulation of the clear ink of the present embodiment will be described in detail. The clear ink (CL) of the present embodiment is formulated by adding the following components to achieve a predetermined concentration.

After sufficiently mixing and stirring these components together, the mixture was then pressure-filtered with a microfilter having a pore size of 2.5 μm (manufactured by FUJIFILM Corporation) to prepare a clear ink having a fine resin particle concentration of 12% by mass.

| | | |
|---|---|---|
| Above-described resin particle dispersion | 60 | parts |
| Zonyl FSO-100 | 0.05 | parts |
| (fluorinated surfactant by DuPont) | | |
| 2-Methyl-1,3-propanediol | 15 | parts |
| 2-Pyrrolidone | 5 | parts |
| Acetylene glycol EO adduct | 0.5 | parts |
| (Manufactured by Kawaken Fine Chemicals Co., Ltd.) | | |

| | |
|---|---|
| Ion exchange water | residual part |

### Discharge Inspection Processing

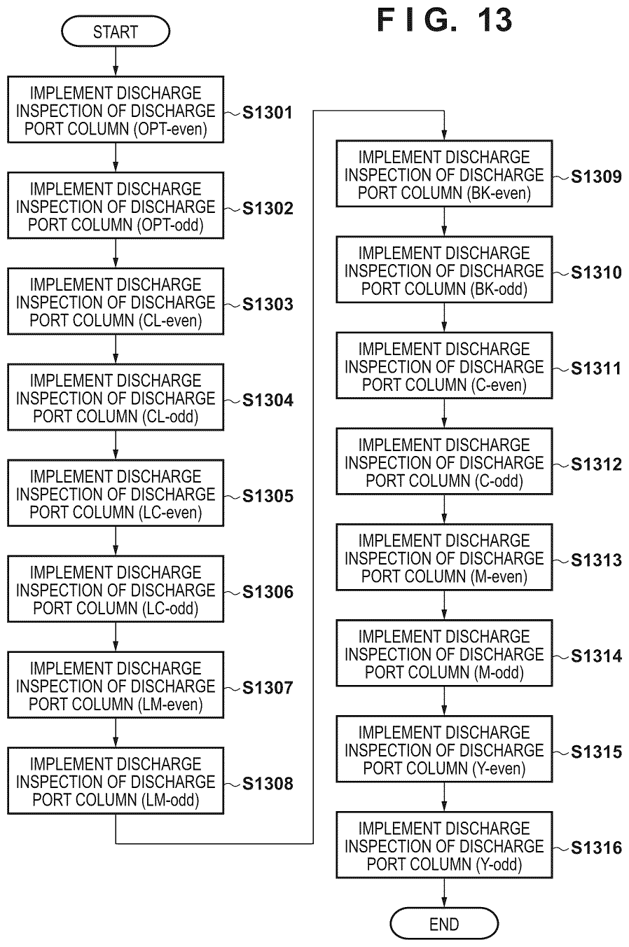

FIG. 13 is a flowchart showing an example of discharge inspection processing executed by the liquid discharge apparatus 1 of the present embodiment. The processing that is executed by the liquid discharge apparatus 1 of FIG. 13 is realized by, for example, a control program stored in a memory such as the ROM 171 being unpacked in the RAM 172 and executed by the CPU 170. Also, the processing of FIG. 13 may, for example, be the processing that is executed in step S602 of FIG. 6.

Since the processing of steps S1301 and S1302 is similar to the processing of steps S1101 and S1102, description thereof is omitted.

In step S1303, the liquid discharge apparatus 1 moves the discharge port column CL-even targeted for inspection among the discharge port columns of the discharge head 11 to the upper part of the inspection unit 16, and then discharges clear ink from the discharge ports 111 and executes discharge inspection of the discharge ports 111.

In step S1304, the liquid discharge apparatus 1 moves the discharge port column CL-odd targeted for inspection among the discharge port columns of the discharge head 11 to the upper part of the inspection unit 16, and then discharges clear ink from the discharge ports 111 and executes discharge inspection of the discharge ports 111, for example.

Since the processing of steps S1305 to S1316 is similar to the processing of steps S1103 and S1114, description thereof is omitted.

As described above, in the present embodiment, the liquid discharge apparatus 1, in the case where the discharge head 11 is capable of discharging clear ink, performs discharge inspection of the discharge head 11 after discharge inspection of the discharge head 12, and implements discharge inspection of the discharge port columns CL-even and CL-odd (not shown) before the discharge port columns 111C to 111BK of the color inks. Also, the liquid discharge apparatus 1 executes discharge inspection of the discharge port columns 111C to 111BK of the color inks in ascending order of colorant concentration. The plurality of types of ink and the reaction solution used in discharge inspection of the discharge heads 11 and 12 reacting inside the inspection unit 16 can thereby be suppressed.

### OTHER EMBODIMENTS

In the above-described embodiments, the liquid discharge apparatus 1 implements discharge inspection of the even and odd columns of the discharge heads 11 and 12 separately, but the present invention is not limited thereto. For example, the liquid discharge apparatus 1 may implement discharge inspection of the even and odd columns at the same time. Specifically, for example, if the interval between the even and odd columns is within the inspection area 1600, the inspection unit 16 may inspect these two columns at the same time. The liquid discharge apparatus 1 is thereby able to inspect the even and odd columns without moving the carriage 10. That is, the time taken for discharge inspection can be shortened.

Also, in the above-described embodiments, a configuration in which the inspection unit 16 has one light emitting element 161 and one light receiving element 160 is described as an example, but the present invention is not limited thereto. For example, the inspection unit 16 may have one light emitting element 161 and a plurality of light receiving elements 160. Also, the inspection unit 16 may have a plurality of light emitting elements 161 and a plurality of light receiving elements 160. Also, the inspection unit 16 may have one light emitting element 161 and a plurality of light receiving elements 160.

Also, in the above-described embodiments, the case where the inspection unit 16 performs discharge inspection using the light emitting element 161 and the light receiving element 160 is described as an example, but the present invention is not limited thereto. The inspection unit 16 may implement discharge inspection using an image capturing apparatus such as a camera, for example. Also, for example, the inspection unit 16 may implement discharge inspection using other sensors such as a pressure sensor, a vibration sensor, and a weight sensor.

Also, in the above-described embodiments, the case where the liquid discharge apparatus 1 fixes the position of the discharge port column targeted for inspection and the inspection unit 16 while performing discharge inspection of the discharge column targeted for inspection is described as an example, but the present invention is not limited thereto. For example, the liquid discharge apparatus 1 may continuously move the carriage 10 in the discharge port column direction while performing discharge inspection of the discharge port column targeted for inspection. The discharge port column direction is, for example, the array direction of the discharge ports in the discharge port column targeted for inspection.

Also, in the above-described embodiments, an example is described in which the discharge head 11 is provided with two discharge port columns consisting of an even column and an odd column for each color ink, but the present invention is not limited thereto. For example, the discharge head 11 may be provided with one discharge port column for each color ink or may be provided with more than two discharge port columns for each color ink. Similarly, the discharge head 12 may be provided with one discharge port column for each type of reaction solution or may be provided with more than two discharge port columns for each type of reaction solution.

Also, in the above-described embodiments, a mode is described in which the control unit 17 is provided inside the liquid discharge apparatus 1, but the present invention is not limited thereto. For example, a configuration may be adopted in which a printer driver (not shown) included in the host computer (image input device 3) to which the liquid discharge apparatus 1 is connected is provided with functions equivalent to the control unit 17. In this case, the host computer is capable of functioning as a control device that performs overall control of the liquid discharge apparatus 1, for example, and also functioning as a data supply device that supplies various types of data to the liquid discharge apparatus 1.

Also, in the embodiments, an inkjet recording apparatus is described as an example of the liquid discharge apparatus 1, but the present invention is not limited thereto. The liquid discharge apparatus 1 may, for example, be an office machine such as a printer, a copier or a facsimile machine, a mass production machine, or a manufacturing apparatus for industrial applications such as a semiconductor device. Also, the manufacturing apparatus for industrial applications such as a semiconductor device may, for example, be a liquid discharge apparatus that discharges resists or the like using a nanoimprint lithography technology or the like. The liquid discharge apparatus 1 may also be a dispenser or the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-016442, filed Feb. 6, 2024 which is hereby incorporated by reference herein in its entirety.

What is claimed is:

1. A liquid discharge apparatus comprising:
a discharge unit configured to discharge a plurality of types of liquid, a housing unit configured to house liquid discharged from the discharge unit in order to inspect a discharge state of the discharge unit; and
a control unit configured to control the discharge unit,
wherein the plurality of types of liquid include a first liquid and a reaction solution that reacts with the first liquid, and
the control unit controls the discharge unit, such that the reaction between the first liquid and the reaction solution is suppressed, in the inspection of the discharge state.

2. The liquid discharge apparatus according to claim 1,
wherein the control unit controls the discharge unit, such that the reaction solution is discharged before the first liquid.

3. The liquid discharge apparatus according to claim 1,
wherein the control unit controls the discharge unit, such that predetermined processing is executed between each discharge of the first liquid and the reaction solution.

4. The liquid discharge apparatus according to claim 2,
wherein the first liquid includes a colorant that is aggregated by the reaction solution.

5. The liquid discharge apparatus according to claim 4,
wherein, in a case where the plurality of types of liquid include a second liquid having a higher concentration of the colorant than the first liquid,
the control unit controls the discharge unit, such that the first liquid is discharged before the second liquid.

6. The liquid discharge apparatus according to claim 4,
wherein, in a case where the plurality of types of liquid include a third liquid having a mixed viscosity when mixed with the reaction solution higher than the first liquid,
the control unit controls the discharge unit, such that the first liquid is discharged before the third liquid.

7. The liquid discharge apparatus according to claim 4,
wherein, in a case where the reaction solution includes a first reaction solution and a second reaction solution that aggregates the colorant more than the first reaction solution,
the control unit controls the discharge unit, such that the second reaction solution is discharged before the first reaction solution.

8. The liquid discharge apparatus according to claim 3,
wherein the predetermined processing is processing for counting a predetermined time.

9. The liquid discharge apparatus according to claim 3,
wherein the predetermined processing is discharge of the plurality of types of liquid onto a printing medium by the discharge unit.

10. The liquid discharge apparatus according to claim 1, further comprising:
an inspection unit configured to inspect the discharge state of the discharge unit, and
the inspection is performed based on a result of the inspection by the inspection unit.

11. The liquid discharge apparatus according to claim 10,
wherein the inspection unit is an optical sensor having a light emitting element and a light receiving element.

12. The liquid discharge apparatus according to claim 10, further comprising:
an acquisition unit configured to acquire information of a position at which the inspection is performed by the inspection unit,
wherein the control unit performs control such that the discharge unit discharges the plurality of types of liquid at the position at which the inspection is performed by the inspection unit, based on the information of the position acquired by the acquisition unit, in the inspection of the discharge state.

13. The liquid discharge apparatus according to claim 1,
wherein the housing unit further includes an absorbent that absorbs the plurality of types of liquid.

14. The liquid discharge apparatus according to claim 1,
wherein the discharge unit discharges the first liquid and the reaction solution from respectively different discharge ports.

15. The liquid discharge apparatus according to claim 1,
wherein the reaction solution is a liquid containing a polyvalent metal salt.

16. The liquid discharge apparatus according to claim 1,
wherein the housing unit is provided in the liquid discharge apparatus in such a manner as to be replaceable by a provider.

17. A liquid discharge method comprising:
discharging a plurality of types of liquid,
housing liquid discharged in the discharging in order to inspect a discharge state of the discharging; and
controlling the discharging,
wherein the plurality of types of liquid include a first liquid and a reaction solution that reacts with the first liquid, and
the discharging is controlled, such that the reaction solution is discharged before the first liquid, in the inspection of the discharge state.

18. A liquid discharge method comprising:
discharging a plurality of types of liquid,
housing liquid discharged in the discharging step in order to inspect a discharge state of the discharging; and
controlling the discharging,
wherein the plurality of types of liquid include a first liquid and a reaction solution that reacts with the first liquid, and
the discharging is controlled, such that predetermined processing is executed between each discharge of the first liquid and the reaction solution, in the inspection of the discharge state.
